(19) United States
(12) Patent Application Publication
(10) Pub. No.: US 2023/0239816 A1
(43) Pub. Date: Jul. 27, 2023

(54) METHOD AND APPARATUS FOR PROVIDING TIMING SYNCHRONIZATION IN WIRELESS COMMUNICATION SYSTEM

(71) Applicant: SAMSUNG ELECTRONICS CO., LTD., Suwon-si (KR)

(72) Inventor: Sangjun MOON, Suwon-si (KR)

(21) Appl. No.: 18/158,972

(22) Filed: Jan. 24, 2023

(30) Foreign Application Priority Data
Jan. 26, 2022 (KR) 10-2022-0011554

(51) Int. Cl. H04W 56/00

(52) U.S. Cl. CPC H04W 56/001

(57) ABSTRACT

The disclosure relates to a 5th generation (5G) or 6th (6G) communication system for supporting higher data rates. A method performed by a 5G core network (5GC) entity for timing synchronization, in a wireless communication system includes transmitting, to an access and mobility management function (AMF), subscription information including location information of at least one of an application function (AF) or a base station, receiving, from the AMF, information on a user equipment (UE) identified based on the location information, identifying a sync status for providing a synchronization service, based on the location information and the information on the UE, and transmitting, to a policy and charging function (PCF), information on the sync status.

### CROSS-REFERENCE TO RELATED APPLICATION

This application is based on and claims priority under 35 U.S.C. § 119 to Korean Patent Application No. 10-2022-0011554, filed on Jan. 26, 2022, in the Korean Intellectual Property Office, the disclosure of which is incorporated by reference herein in its entirety.

### BACKGROUND

### 1. Field

The disclosure relates generally to a wireless communication system. More particularly, the disclosure relates to a method and an apparatus for providing a timing synchronization in wireless communication systems.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, New Radio (NR) User Equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5 G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The disclosed embodiment provides an apparatus and a method for effectively providing a service in a wireless communication system.

According to an exemplary embodiment, a method performed by a 5th generation (5G) core network (5GC) entity for timing synchronization, in a wireless communication system, comprising: transmitting subscription information comprising location information of at least one of an application function (AF) or a base station to an access and mobility management function (AMF), receiving information of a terminal identified based on the location information from the AMF, identifying a sync status for providing a synchronization service, based on the location information and the identified terminal information, and transmitting information of the sync status to a policy and charging function (PCF).

According to an exemplary embodiment, a 5th generation (5G) core network (5GC) entity in a wireless communication system, comprising: at least one transceiver and at least one processor functionally coupled with the at least one transceiver, wherein the at least one processor is configured to, transmit subscription information comprising location information of at least one of an application function (AF) or a base station to an access and mobility management function (AMF), receive information of a terminal identified based on the location information from the AMF, identify a sync status for providing a synchronization service, based on the location information and the identified terminal information, and transmit information of the sync status to a policy and charging function (PCF).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A illustrates a wireless communication system according to embodiments of the disclosure;

FIG. 1B illustrates a base station configuration in a wireless communication system according to embodiments of the disclosure;

FIG. 1C illustrates a terminal configuration in a wireless communication system according to embodiments of the disclosure;

FIG. 1D illustrates a core network entity configuration in a wireless communication system according to embodiments of the disclosure;.

FIG. 2A illustrates an example of providing timing redundancy using a plurality of timing sources when a 5th generation system (5GS) provides a timing synchronization to a terminal according to embodiments of the disclosure;

FIG. 2B illustrates an example of a network structure connected to an external application function (AF) when a 5GS provides timing synchronization to a terminal according to embodiments of the disclosure;

FIG. 3A illustrates an example of information flow in a network connected to an external AF when a 5GS provides timing synchronization to a terminal according to embodiments of the disclosure;

FIG. 3B illustrates a flowchart of a 5G core network (5GC) (e.g., a time sensitive communications and time synchronization function (TSCTSF) or a network exposure function (NEF)) in a network connected to an external AF when a 5GS provides a timing synchronization to a terminal according to embodiments of the disclosure;

FIG. 4 illustrates an example in which a 5GC transmits a sync status to a terminal via session management (SM) non-access stratum (NAS) signaling, and to an AF via a control plane (CP) according to embodiments of the disclosure;

FIG. 5 illustrates an example in which a 5GC transmits a sync status to a terminal via access and mobility management (AM) NAS signaling, and to an AF via a CP according to embodiments of the disclosure;

FIG. 6 illustrates an example in which a 5GC transmits a sync status to a terminal via access stratum (AS) (system information block (SIB), radio resource control (RRC) signaling) signaling, and to an AF via a CP according to embodiments of the disclosure;

FIG. 7 illustrates an example in which a 5GC notifies a sync status to an AF, and the AF forwards the sync status to a terminal via a user plane (UP) according to embodiments of the disclosure;

FIG. 8 illustrates an example in which a 5GC notifies a sync status to an AF, and the 5GC transmits SM NAS signaling to a terminal at a request of the AF according to embodiments of the disclosure;

FIG. 9 illustrates an example in which a 5GC notifies a sync status to an AF, and the 5GC transmits AM NAS signaling to a terminal at a request of the AF according to embodiments of the disclosure;

FIG. 10 illustrates an example in which a 5GC notifies a sync status to an AF, and the 5GC transmits AS (SIB, RRC signaling) signaling to a terminal at a request of the AF according to embodiments of the disclosure; and

FIG. 11 illustrates an example in which a 5GC notifies a sync status to an AF, and the AF forwards the sync status to a terminal via a UP according to embodiments of the disclosure.

Throughout the drawings, it should be noted that like reference numbers are used to depict the same or similar elements, features, and structures.

### DETAILED DESCRIPTION

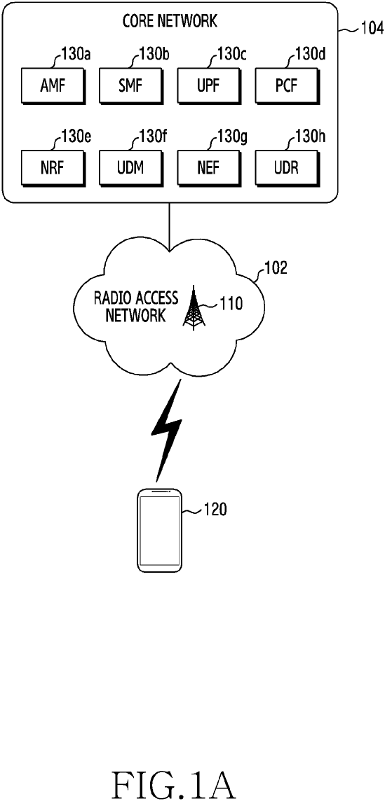

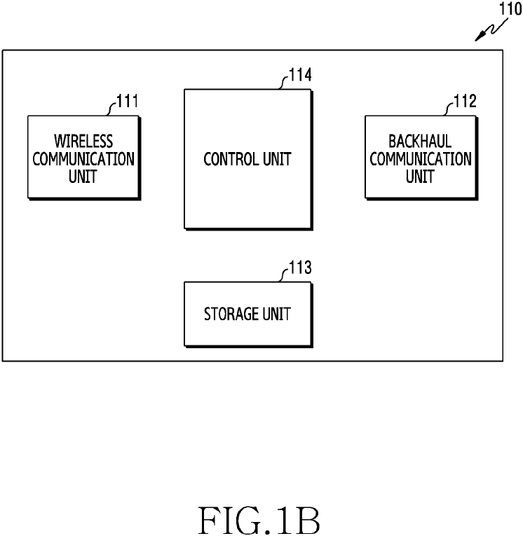

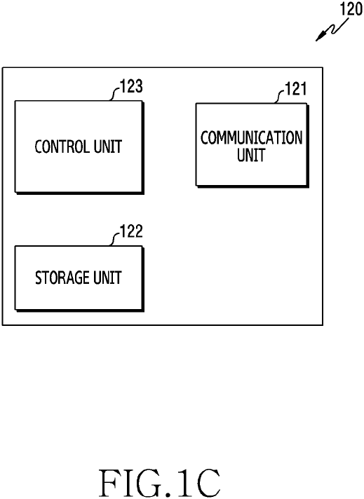

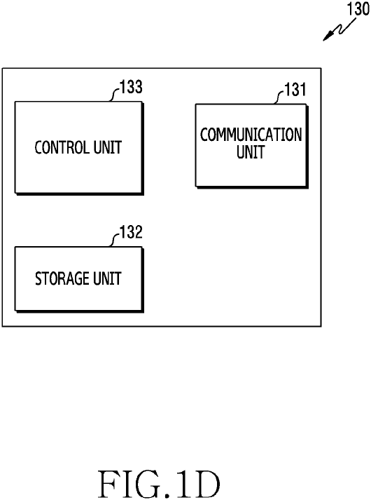

FIGS. 1 through 11, discussed below, and the various embodiments used to describe the principles of the disclosure in this patent document are by way of illustration only and should not be construed in any way to limit the scope of the disclosure. Those skilled in the art will understand that the principles of the disclosure may be implemented in any suitably arranged system or device.

Terms used in the disclosure are used merely to describe specific embodiments, and may not intend to limit the scope of other embodiments. Singular expressions may include plural expressions unless the context clearly indicates otherwise. Terms used herein, including technical or scientific terms, may have the same meaning as those commonly understood by a person of ordinary skill in the technical field described in the disclosure. Among the terms used in the disclosure, terms defined in a general dictionary may be interpreted as having the same or similar meaning as those in the context of the related art, and unless explicitly defined in the disclosure, may not be interpreted as ideal or excessively formal meanings. In some cases, even terms defined in the disclosure may not be interpreted to exclude embodiments of the disclosure.

A hardware-based approach will be described as an example in various embodiments of the disclosure to be described hereinafter. However, various embodiments of the disclosure include technology which uses both hardware and software, and thus various embodiments of the disclosure do not exclude a software-based approach.

Also, in the disclosure, to determine whether a specific condition is satisfied or fulfilled, expressions such as greater than or less than are used but is merely an expression by way of example and does not exclude expressions of equal to or greater than or equal to or less than. A condition expressed as “greater than or equal to” may be replaced by “greater than,” a condition expressed as “less than or equal to” may be replaced by “less than,” and a condition expressed as “greater than or equal to and less than” may be replaced by “greater than and less than or equal to.”

Hereafter, operational principles of the disclosure will be described in detail with reference to the accompanying drawings. If it is determined that a detailed description of a related known function or configuration may unnecessarily obscure the subject matter of the disclosure, the detailed description will be omitted in describing the disclosure. Terms to be described are terms defined in consideration of the functions of the disclosure, which may vary according to a user’s or operator’s intent or practice. Hence, their definition should be made based on contents throughout this specification.

Terms for identifying access nodes, terms for indicating network entities, terms for indicating messages, terms for indicating interfaces between network entities, and terms for indicating various identification information used in the following explanation are illustrated for convenience of explanation. Accordingly, the disclosure is not limited to the following terms and other terms having the same technical meaning may be used. For example, terms indicating signals (e.g., a message, information, a preamble, a signal, signaling, a sequence, a stream), terms indicating calculation states (e.g., a step, an operation, a procedure), terms indicating data (e.g., a packet, a user stream, information, a bit, a symbol, and codeword), terms indicating channels, terms indicating control information (e.g., downlink control information (DCI), a medium access control element (MAC CE), radio resource control (RRC) signaling), terms indicating network entities, terms indicating interfaces (e.g., N1, N2, N3, etc.) between network entities, and terms indicating components of a device used in the following explanation are illustrated only for convenience of description. Accordingly, the disclosure is not limited to the terms to be described, and other terms having the same technical meaning may be used.

In the following description, the disclosure may use terms and names defined in 5th generation system (5GS) and new radio (NR) standards which are the latest standards specified by the 3rd generation partnership project (3GPP) group, for the convenience of description. However, the disclosure is not limited by these terms and names, and may be applied in the same way to systems conforming to other standards. Particularly, the disclosure may be applied to the 3GPP 5GS/NR (5G mobile communication standard). Hereafter, embodiments of the disclosure shall be elucidated by referring the accompanied drawings.

If an application such as a smart grid is utilized on a network system, accurate timing synchronization or time sync is required between terminals. The 5GS may provide the time sync between terminals. A timing sync method using the 5GS, which uses two or more timing sources of the 5GS, may provide stable timing sync between terminals by, even if one timing source has an error, using the other timing source. The disclosure relates to a method for supporting timing redundancy to use a plurality of sources as timing sources of the 5GS. That is, if the 5GS of the 3GPP provides a synchronization service to a terminal as a synchronization source, a timing source used by a 3GPP network (e.g., 5GS)is also duplexed to raise stability. To support the timing redundancy (i.e., a plurality of timing sources), it is necessary to transmit a synchronization service status provided in the 3GPP network to a terminal and an application or an application function (AF) requesting the synchronization service. Hereinafter, the disclosure explains a method for transmitting synchronization service status (hereafter, synchronization status) information to support the timing redundancy. Hence, the disclosure may, if the 5GS provides the synchronization service, share the synchronization service status, designate coverage, support subscription information reference, and thus provide a stable synchronization service.

FIG. 1A illustrates a wireless communication system according to embodiments of the disclosure.

Referring to FIG. 1A, the wireless communication system may include a radio access network (RAN) 102 and a core network (CN) 104.

The RAN 102 is a network directly connected to a user device, for example, a terminal 120, and is an infrastructure which provides radio access to the terminal 120. The RAN 102 may include a set of base stations including a base station 110, and may perform communication via interfaces established between the base stations. At least some of the interfaces between the base stations may be wired interfaces or wireless interfaces. The base station 110 may have a structure divided into a central unit (CU) and a distributed unit (DU). In this case, a single CU may control a plurality of DUs. The base station 110 may be referred to as, in addition to the base station, an “access point (AP),” a “next generation node B (gNB),” a “5G node,” a “wireless point,” a “transmission/reception point (TRP),” or other term having the equivalent technical meaning. The terminal 120 accesses the RAN 102, and communicates with the base station 110 over a radio channel. The terminal 120 may be referred to as, in addition to the terminal, a “user equipment (UE),” a “mobile station,” a “subscriber station,” a “remote terminal,” a “wireless terminal,” a “user device,” or other term having the equivalent technical meaning.

The CN 104, which is a network for managing the whole system, controls the RAN 102 and processes data and control signals for the terminal 120 transmitted or received via the RAN 102. The CN 104 performs various functions such as controlling a user plane and a control plane, processing mobility, managing subscriber information, charging, and interworking with systems of other types (e.g., a long term evolution (LTE) system). To carry out the described various functions, the CN 104 may include a plurality of entities functionally separated with different network functions (NFs). For example, the CN 104 may include an access and mobility management function (AMF) 130a, a session management function (SMF) 130b, a user plane function (UPF) 130c, a policy and charging function (PCF) 130d, a network repository function (NRF) 130e, unified data management (UDM) 130f, a network exposure function (NEF) 130g, and a unified data repository (UDR) 130h.

The terminal 120 is connected to the RAN 102 and accesses the AMF 130a which performs a mobility management function of the CN 104. The AMF 130a is a function or a device which manages both access of the RAN 102 and mobility management of the terminal 120. The SMF 130b is an NF which manages a session. The AMF 130a is connected to the SMF 130b, and routes a session related message of the terminal 120 to the SMF 130b. The SMF 130b is connected to the UPF 130c, allocates a user plane resource to be provided to the terminal 120, and establishes a tunnel for transmitting data between the base station 110 and the UPF 130c. The PCF 130d controls information related to a policy and charging of a session used by the terminal 120. The NRF 130e stores information of NFs installed in a mobile communication provider network, and performs a function of notifying the stored information. The NRF 130e may be connected to all the NFs. If starting to operate in the service provider network, each NF notifies the NRF 130e that a corresponding NR is operating in the network, by registering at the NRF 130e.

The UDN 130f is an NF for serving a similar role to a home subscriber server (HSS) of a 4G network, and stores subscription information of the terminal 120 or a context used by the terminal 120 in the network. The NEF 130g serves to connect a 3rd party server and the NF in the 5G mobile communication system. For example, the 3rd party server (or a 3rd party application) may be an application function (AF). The NEF 130g provides or updates data to the UDR 130h, or acquires data. The UDR 130h stores the subscription information of the terminal 120, stores policy information, stores data exposed to outside, or stores information required for the 3rd party application. The UDR 130h also provides the stored data to other NF.

FIG. 1B illustrates a configuration of a base station in a wireless communication system according to embodiments of the disclosure.

The configuration illustrated in FIG. 1B may be understood as a configuration of a base station 110. A term “-unit” or “~er” used hereinafter may indicate a unit for processing at least one function or operation, and may be implemented in hardware, software, or a combination of hardware and software.

Referring to FIG. 1B, the base station 110 may include a wireless communication unit 111, a backhaul communication unit 112, a storage unit 113, and a control unit 114.

The wireless communication unit 111 performs functions for transmitting or receiving a signal over a radio channel. For example, the wireless communication unit 111 performs a conversion function between a baseband signal and a bit stream according to a physical layer standard of the system. For example, in data transmission, the wireless communication unit 111 generates complex symbols by encoding and modulating a transmit bit stream. Also, in data reception, the wireless communication unit 111 restores a receive bit stream by demodulating and decoding a baseband signal.

Also, the wireless communication unit 111 up-converts a baseband signal into an RF band signal and transmits the same via an antenna, and down-converts an RF band signal received through an antenna into a baseband signal. For doing so, the wireless communication unit 111 may include a transmit filter, a receive filter, an amplifier, a mixer, an oscillator, a digital to analog convertor (DAC), an analog to digital convertor (ADC), and the like. Also, the wireless communication unit 111 may include a plurality of transmit/receive paths. Further, the wireless communication unit 111 may include at least one antenna array including a plurality of antenna elements.

In terms of hardware, the wireless communication unit 111 may include a digital unit and an analog unit, and the analog unit may include a plurality of sub-units according to an operating power, an operating frequency, and so on. The digital unit may be implemented with at least one processor (e.g., a digital signal processor (DSP)).

The wireless communication unit 111 transmits and receives the signal as described above. Accordingly, all or a part of the wireless communication unit 111 may be referred to as a “transmitter,” a “receiver,” or a “transceiver.” The transmission and reception conducted over the radio channel is used to embrace the above-described processing performed by the wireless communication unit 111 in the following description.

The backhaul communication unit 112 provides an interface for communicating with other nodes in the network. That is, the backhaul communication unit 112 converts a bit stream transmitted from the base station to other node, for example, other access node, another base station, an upper node, a core network, and so on, into a physical signal, and converts a physical signal received from other node into a bit stream.

The storage unit 113 stores data such as a basic program, an application program, and setting information for the operation of the base station. The storage unit 113 may be configured with a volatile memory, a non-volatile memory, or a combination of a volatile memory and a non-volatile memory. In addition, the storage unit 113 provides the stored data at a request of the control unit 114.

The control unit 114 controls general operations of the base station. For example, the control unit 114 transmits and receives a signal through the wireless communication unit 111 or the backhaul communication unit 112. In addition, the control unit 114 records and reads data in and from the storage unit 113. The control unit 114 may perform functions of a protocol stack required by the communication standard. According to another implementation, the protocol stack may be included in the wireless communication unit 111. For doing so, the control unit 114 may include at least one processor. According to various embodiments, the control unit 114 may control to perform synchronization using a wireless communication network. For example, the control unit 114 may control the base station to carry out operations according to various embodiments to be described.

FIG. 1C illustrates a configuration of a terminal in a wireless communication system according to embodiments of the disclosure.

The configuration shown in FIG. 1C may be understood as a configuration of a terminal 120. A term “-unit” or “~ef” used hereinafter may indicate a unit for processing at least one function or operation, and may be implemented in hardware, software, or a combination of hardware and software.

Referring to FIG. 1C, the terminal 120 may include a communication unit 121, a storage unit 122, and a control unit 123.

The communication unit 121 performs functions for transmitting or receiving a signal over a radio channel. For example, the communication unit 121 performs a conversion function between a baseband signal and a bit stream according to a physical layer standard of the system. For example, in data transmission, the communication unit 121 generates complex symbols by encoding and modulating a transmit bit stream. Also, in data reception, the communication unit 121 restores a receive bit stream by demodulating and decoding a baseband signal. Also, the communication unit 121 up-converts a baseband signal into an RF band signal and transmits the same via an antenna, and down-converts an RF band signal received through an antenna into a baseband signal. For example, the communication unit 121 may include a transmit filter, a receive filter, an amplifier, a mixer, an oscillator, a DAC, an ADC, and the like.

Also, the communication unit 121 may include a plurality of transmit/receive paths. Further, the communication unit 121 may include at least one antenna array including a plurality of antenna elements. In terms of hardware, the communication unit 121 may include a digital circuit and an analog circuit (e.g., a radio frequency integrated circuit (RFIC)). Herein, the digital circuit and the analog circuit may be implemented in a single package. The communication unit 121 may include a plurality of RF chains. Further, the communication unit 121 may perform beamforming.

The communication unit 121 transmits and receives the signal as described above. Accordingly, all or a part of the communication unit 121 may be referred to as “a transmitter,” “a receiver,” or “a transceiver.” Also, the transmission and reception conducted over the radio channel is used to embrace the above-described processing performed by the communication unit 121 in the following description.

The storage unit 122 stores data such as a basic program, an application program, and setting information for the operation of the terminal. The storage unit 122 may be configured with a volatile memory, a non-volatile memory, or a combination of a volatile memory and a non-volatile memory. The storage unit 122 provides the stored data at a request of the control unit 123.

The control unit 123 controls general operations of the terminal. For example, the control unit 123 transmits and receives a signal through the communication unit 121. In addition, the control unit 123 records and reads data in and from the storage unit 122. The control unit 123 may perform functions of a protocol stack required by the communication standard. For doing so, the control unit 123 may include at least one processor or a micro-processor, or may be a part of a processor. A part of the communication unit 121 and the control unit 123 may be referred to as a communication processor (CP). According to various embodiments, the control unit 123 may control to perform synchronization using a wireless communication network. For example, the control unit 123 may control the terminal to perform operations according to various embodiments to be described.

FIG. 1D illustrates a configuration of a core network entity in a wireless communication system according to embodiments of the disclosure.

A core network entity 130 shown in FIG. 1D may be understood as a configuration of a device having at least one function of the AMF 130a, the SMF 130b, the UPF 130c, the PCF 130d, the NRF 130e, the UDM 130f, the NEF 130g, and the UDR 130h of FIG. 1A. A term “-unit” or “~er” used hereinafter may indicate a unit for processing at least one function or operation, and may be implemented in hardware, software, or a combination of hardware and software.

Referring to FIG. 1D, the core network entity 130 may include a communication unit 131, a storage unit 132, and a control unit 133.

The communication unit 131 provides an interface to communicate with other devices in a network. That is, the communication unit 131 converts a bit stream transmitted from the core network object to other device into a physical signal, and converts a physical signal received from other device into a bit stream. That is, the communication unit 131 may transmit or receive a signal. Accordingly, the communication unit 131 may be referred to as a modem, a transmitter, a receiver, or a transceiver. In this case, the communication unit 131 enables the core network entity to communicate with other devices or systems via a backhaul connection (e.g., a wired backhaul or a radio backhaul) or the network.

The storage unit 132 stores data such as a basic program, an application program, and setting information for the operation of the core network entity. The storage unit 132 may be configured with a volatile memory, a non-volatile memory, or a combination of a volatile memory and a non-volatile memory. The storage unit 132 provides the stored data at a request of the control unit 133.

The control unit 133 controls general operations of the core network entity. For example, the control unit 133 transmits and receives a signal via the communication unit 131. Also, the control unit 133 records and reads data in and from the storage unit 132. For doing so, the control unit 133 may include atleast one processor. According to various embodiments, the control unit 133 may control to perform synchronization using a wireless communication network. For example, the control unit 133 may control the core network entity to carry out operations according to various embodiments to be described.

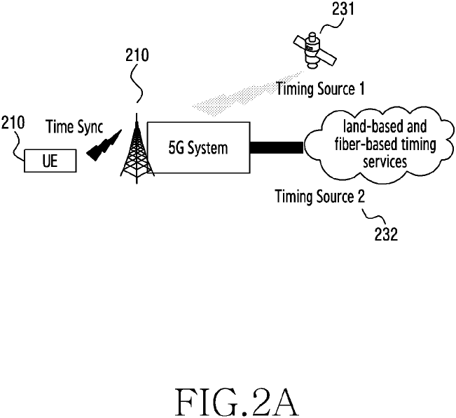

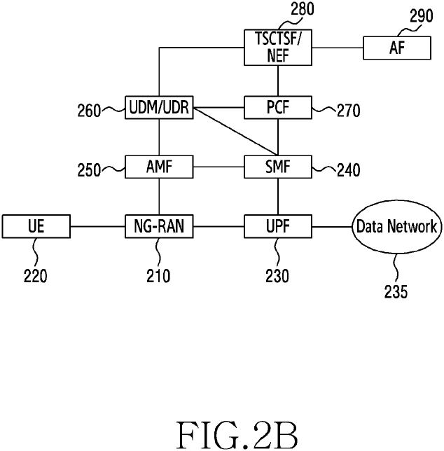

FIG. 2A illustrates an example of providing timing redundancy using a plurality of timing sources, if a 5GS provides timing synchronization to a terminal according to embodiments of the disclosure.

A base station 210 and a terminal 220 of FIG. 2A may be understood in the same manner as the baes station 110 and the t4erminal 120 of FIG. 1A.

Referring to FIG. 2A, the base station 210 may provide a timing synchronization service to the terminal (or the UE) 220. The base station 210 may use a plurality of timing sources, in providing the timing synchronization service. According to an embodiment, the base station 210 may be connected to a first timing source 231 and a second timing source 232. The base station 210 may be connected to the first timing source 231, to provide the timing synchronization service to the terminal 220 using the first timing source 231. Also, the base station 210 may be connected to the second timing source 232, to provide the timing synchronization service to the terminal 220 using the second timing source 232. As such, using the plurality of the timing sources at the base station 210 may be referred to as the timing redundancy. While the base station 210 is connected with the timing sources to facilitate the explanation in FIG. 2A, connecting the base station 210 to the timing sources may be understood in the same manner as connecting the 5GS to the timing sources.

Referring to FIG. 2A, according to the timing source used by the 5GS, information of a difference between timing information provided by the 5GS and coordinated universal time (UTC), or an accuracy difference (i.e., error) from the UTC may be provided to the terminal and an application.

FIG. 2B illustrates an example of a network structure connected to an external AF, if the 5GS provides the timing synchronization to a terminal according to embodiments of the disclosure.

Network entities of FIG. 2B may be understood in the same manner as the network entities shown in FIG. 1A. For example, a terminal 220 of FIG. 2B may be understood in the same manner as the terminal 120 of FIG. 1A. A next generation (NG)-RAN 210 of FIG. 2B may be understood in the same manner as the base station 210 of FIG. 1A.

Referring to FIG. 2B, an NEF 280 may manage connection between the 5GS and the AF. A time sensitive communications and time synchronization function (TSCTSF) 280 may manage a timing information related function in the 5GS and obtain timing source information of the 5GS. The 5GS may have a plurality of timing sources (or sync sources), and the synchronization status may vary depending on the sync source. For example, if the 5GS uses the first timing source and the reference UTC is 1 hour 00 minute 00 second, an absolute time of the 5GS may indicate 1 hour 00 minute 01 second. That is, a difference (error) of 1 second may occur between the 5GS absolute time and the UTC every 1 hour.

In this case, information of the 1-second error based on 1 hour may be the sync status. By contrast, if the 5GS uses the second timing source and the UTC is 1 hour 00 minute 00 second, the 5GS absolute time may indicate 1 hour 00 minute 0.5 second. That is, a difference (error) of 1 second may occur between the 5GS absolute time and the UTC every 1 hour. In this case, information of the 1-second error based on 1 hour may be the sync status. A PCF 270 associates a policy of the 5GS with an SMF 240, an AMF 250 and the UE 220. The SMF 240 manages protocol data unit (PDU) session setup and quality of service (QoS) setup per flow, and controls a UPF 230. The AMF 250 is connected to the NG-RAN 230 and manages mobility of the UE 220. The UE 220 may communicate with the AMF 250 and the SMF 240 via a control plane (CP) to transmit and receive a signaling message such as registration and PDU session setup, and may be connected to the UPF 230 via a user plane (UP) to transmit and receive user traffic to and from a data network (DN) 235.

The UE 220 may transmit and receive a signal to and from the NG-RAN 210 via the CP. This may be referred to as access stratum (AS) (or AS signaling). The UE 220 may transmit and receive a signal to and from the AMF 250 or the SMF 240 through the CP via the NG-RAN 210. This may be referred to as non-AS (NAS) (or NAS signaling). A UDM/UDR 260 may be connected to the SMF 240, the AMF 250, the PCF 270, and the TSCTSF/NEF 280. At this time, the UDM/UDR 260 may store subscription information or context of the UE 220, and provide the stored data to other NF.

Referring to FIG. 2B, if the 5GS provides the sync service, the 5GS may store the sync service status (or sync status) with UEs and AF(s). If the 5GS provides the sync service, the 5GS may designate sync service coverage. If the 5GS provides the sync service, the 5GS may refer to subscription information of the sync service.

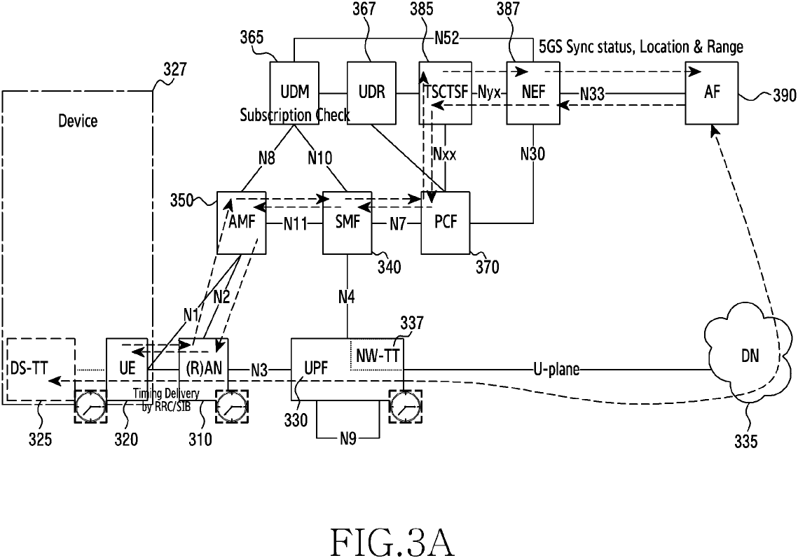

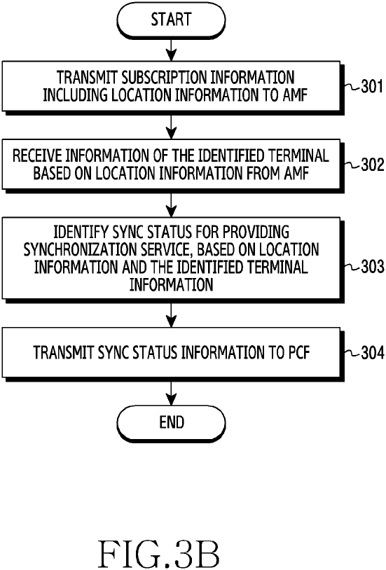

FIG. 3A illustrates an example of information flow in a network connected with an external AF, if a 5GS provides time synchronization to a terminal according to embodiments of the disclosure.

Description on network entities or NFs of FIG. 3A may apply the descriptions of FIG. 1A through FIG. 2B. Accordingly, redundant description of FIG. 1A through FIG. 2B shall be omitted.

Referring to FIG. 3A, network entities or NFs may be connected via interfaces. For example, an NG-RAN 310 and an AMF 350 may be connected via an N2 interface. An SMF 340 and a UPF 330 may be connected via an N4 interface. An AF 390 and an NEF 387 may be connected via an N33 interface. The UPF 330 and a DN 335 may be connected via the UP.

Referring to FIG. 3A, the UPF 330 may include a network-side (NW)-time sensitive network (TSN) translator (TT) 337. A device 327 may include a UE 320 and a device-side (DS)-TT 325.

Unlike FIG. 2B, FIG. 3A separately illustrates a UDM 365 and a UDR 367 but this is merely to ease the description and is not construed as different structures. That is, FIG. 1A,

FIG. 2B and FIG. 3A may represent the same network structure. Also, a TSCTSF 385 and a NEF 387 may be understood in the same manner.

Embodiments in which the 5GS transmits information to the AF or the terminal are as follows.

1a. The 5GC (the TSCTSF 385 or the NEF 387) transmits the sync status to the UE 320 using NAS, AS, or UP:
A. Deliver using AM NAS signaling;
B. Deliver using SM NAS signaling;
C. Deliver using AS signaling (SIB, RRC signaling); and/or
D. The AF 390 notifies to the UE 320 using the UP.

1b. The 5GS (the TSCTSF 385 or the NEF 387) transmits the sync status to the AF 390:
A. The TSCTSF 385 or the NEF 387 transmits to the AF 390; and/or
B. The UE 320 notified from the 5GS notifies to the AF 390 using the UP.

2. A method for the 5GS to designate the sync service coverage if the 5GS provides the sync service, wherein the AF 390 designates the coverage in sync service configuration/modification/deletion of the 5GS and the 5GS identifies the UE 320 or a cell interpreted and applied based on the RAN 310:
A. The TSCTSF 385 determines; and/or
B. The AF 390 determines.

3. The UE 320 operates by identifying subscription information (sync service : level, allowed area, time, etc.) related to the sync service in the 5GS:
- A. Identify the subscription information; and/or
- B. Not identify the subscription information.

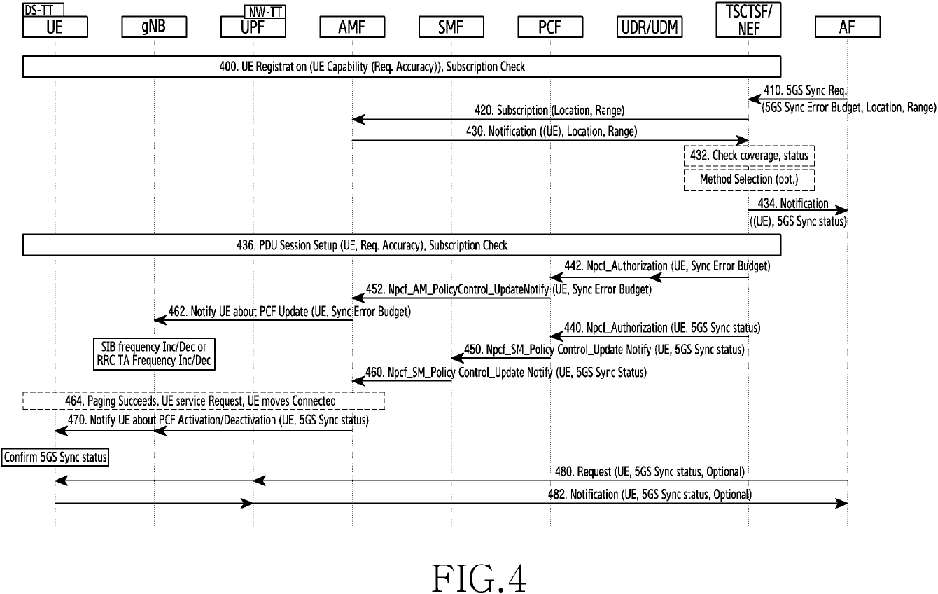

As above, the 5GS may, if providing the synchronization service, deliver the sync status, the coverage, and the subscription information between the UE and the AF in the disclosure. That is, the 5GS may deliver the information (e.g., sync status, coverage, and subscription information) related to the synchronization service by combining the embodiments 1a, 1b, 2 and 3. For example, the 5GS may deliver the sync status, the coverage, and the subscription information related to the synchronization service to the UE and the AF by combining A of the embodiment 1a, A of the embodiment 1B, A of the embodiment 2 and A of the embodiment 3. Also, the 5GS may deliver the sync status, the coverage, and the subscription information related to the synchronization service to the UE and the AF by combining B of the embodiment 1a, A of the embodiment 1B, A of the embodiment 2 and A of the embodiment 3. In addition, the 5GS may deliver the sync status, the coverage, and the subscription information related to the synchronization service to the UE and the AF by combining A of the embodiment 1a, A of the embodiment 1B, B of the embodiment 2 and A of the embodiment 3. The following FIG. 4 through FIG. 11 elucidate the signaling of the 5GS for delivering the synchronization service information according to embodiments of the disclosure.

FIG. 3B illustrates a flowchart of a 5G core network (5GC) (e.g., the TSCTSF or the NEF) in the network connected with the external AF, if the 5GS provides the timing synchronization to the terminal according to embodiments of the disclosure.

Description on network entities or NFs of FIG. 3B may apply the descriptions of FIG. 1A through FIG. 3A. Accordingly, redundant descriptions of FIG. 1A through FIG. 3A shall be omitted. Hereafter, a base station may indicate the RAN 310, and a terminal may indicate the UE 320. The 5GS (e.g., the TSCTSF or the NEF) may indicate the TSCTSF 385 or the NEF 387, an AF may indicate the AF 390, an AMF may indicate the AMF 350, and a PCF may indicate the PCF 370.

Referring to FIG. 3B, the TSCTSF or the NEF may transmit subscription information including AF or base station location information to the AMF in operation 301.

In operation 302, the TSCTSF or the NEF may receive information of a terminal identified based on the location information from the AMF. The location information may include location information of at least one of the AF or the base station.

In operation 303, the TSCTSF or the NEF may identify, check or determine the sync status for providing the synchronization service, based on the location information and the identified terminal information.

In operation 304, the TSCTSF or the NEF may transmit sync status information to the PCF.

The above operations (e.g., operations 301 through 304) are described in detail in FIG. 4.

FIG. 4 illustrates an example in which a 5GC determines and transmits a sync status to a terminal via SM NAS signaling, and to an AF via a CP according to embodiments of the disclosure.

Description on network entities (e.g., a UE, a gNB, an NF) of FIG. 4 may apply the descriptions of FIG. 1A through FIG. 3B. Accordingly, detailed description thereof shall be omitted. FIG. 4 illustrates that the UE includes the D S-TT, but the disclosure is not limited thereto. That is, the UE may be connected to the DS-TT as shown in FIG. 3A. The TSCTSF and the NEF may be independently configured as separate NFs, or may be configured as one NF. A 5GS sync NF to be described may indicate an NF for performing specific function and operation.

Referring to FIG. 4, the signaling example of FIG. 4 may be utilized if the UE establishes a plurality of PDU sessions and only a specific one of the PDU session uses the sync service. However, the embodiment of FIG. 4 is not applied only to the above situation, and the embodiment is merely to facilitate the explanation.

In operation 400, the terminal (or the UE) may transmit a requirement related to time sync accuracy to the 5GC through 5GS registration. The 5GC may identify subscription information such as 5GS sync service availability. If identifying the subscription information, the 5GC may further store details of the subscription information in the UDM.

In an embodiment, the AF may request the 5GC to provide the synchronization service to the UE in operation 410. For example, the AF may request a 5GS synchronization service from the TSCTSF/NEF. At this time, the AF may provide 5GC sync error budget information. In addition, the AF may designate a condition of the terminal. For example, the AF may provide information for the UE registration with respect to an identifier (e.g., a UE ID, a UE group ID, etc.) such as a generic public subscription identifier (GPSI) of the terminal. Also, the AF may provide information for the PDU session establishment such as data network name (DNN)/single-network slice selection assistance information (S-NSSAI). Further, the AF may provide a coverage condition.

Herein, the coverage condition may indicate geographical location information (or location information). For example, the coverage condition may limit a range by displaying center coordinates and a radius based on the center coordinates. Herein, the center coordinates may indicate a latitude and a longitude of the AF, and the radius may indicate a coverage range required by the AF. Alternatively, the center coordinates may indicate a location of the gNB, and the radius may indicate coverage serviceable by the base station. In an embodiment, the coverage condition may be preset in a service provider network. In this case, operation 410 may be omitted.

The NEF may change the geographic location information to coordinates and the radius. Alternatively, the location information may be represented based on a cell ID. The UE ID received as the GPSI may be changed to an ID such as subscription permanent identifier (SUPI) used only inside the 5GS. Changing the TSCTSF or a separate 5GS sync NF may be performed inside the 5GC.

In an embodiment, if operation 410 precedes operation 400, the AF may provide information of the UE registration with respect to the identifier (e.g., a UE ID, a UE group ID, etc.) such as GPSI of the UE. Also, the AF may provide information of the PDU session establishment such as DNN/S-NSSAI. Further, the information such as DNN/S-NSSAI may be stored in the UDR. If identifying UE registration satisfying a specific condition in operation 400, the UDR may notify the identified UE registration to the TSCTSF to perform from operation 420.

In an embodiment, even if the AF does not request the 5GC to provide the synchronization service to the terminal in operation 410, the 5GC itself may determine to provide the synchronization service to the terminal. For example, if the TSCTSF or the NEF determines to provide the synchronization service to the terminal, operations after operation 420 may be performed without the request of the AF (e.g., operation 410).

In operation 420, the TSCTSF or the 5GS sync NF may transmit to the AMF a request to notify of a terminal which is identified to match based on the location information. For example, the TSCTSF or the NEF may transmit subscription information including the location information and the range to the AMF. Hence, the AMF, upon receiving the subscription information, may identify the request to notify of the UE terminal to match based on it.

In operation 430, the AMF may notify terminals identified based on the location information to the TSCTSF or the 5GS sync NF.

In operation 432, the TSCTSF or the 5GS sync NF may identify the coverage condition, and identify a 5GS sync status based on the coverage condition. If the 5GS sync status is changed, operation 432 may be performed. In operation 432, the TSCTSF or the 5GS sync NF may identify whether the UE requirement is satisfied, by considering time sync accuracy required by the terminal and a current time sync status provided by the 5GS. If satisfying the UE requirement, the 5GS may perform internal setup to provide the sync accuracy to the terminal. The 5GS may determine whether to transmit the 5GS sync status to the UE and the AF.

The 5GS may have a plurality of sync sources, and the current sync status may differ depending on the sync source. For example, if the 5GS uses a first timing source and the reference UTC indicates 1 hour 00 minute 00 second, the 5GS absolute time may indicate 1 hour 00 minute 01 second. That is, a different (error) of 1 second may occur every one hour between the 5GS absolute time and the UTC. In this case, information of the 1-second error based on 1 hour may be the sync status. By contrast, if the 5GS uses a second timing source and the reference UTC indicates 1 hour 00 minute 00 second, the 5GS absolute time may indicate 1 hour 00 minute 0.5 second. That is, a different (error) of 1 second may occur every one hour between the 5GS absolute time and the UTC. In this case, information of the 1-second error based on 1 hour may be the sync status.

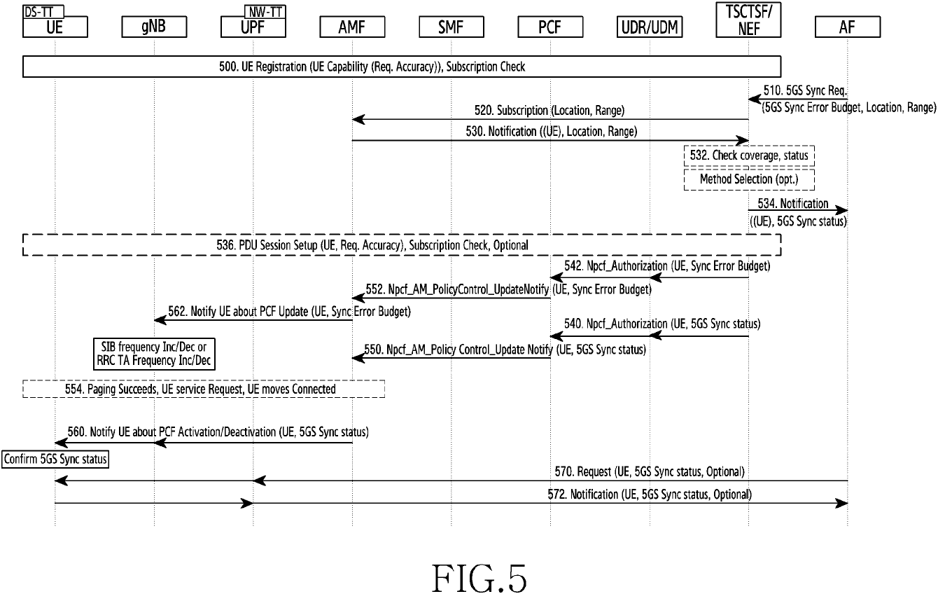

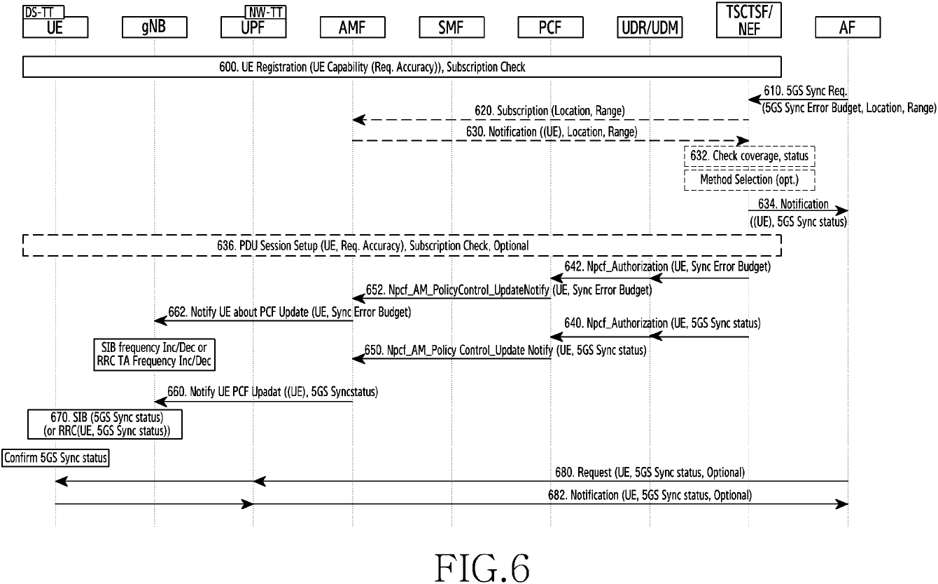

The 5GS may select a method for delivering the sync status to the UE or the AF. That is, a plurality of PDU sessions may be used for one terminal and a method of FIG. 5 may be adopted. At this time, if only one of the PDU sessions is identified at the terminal, the method of FIG. 4 may be applied. Alternatively, if it is necessary to deliver the 5GS sync status to a plurality of terminals of one cell, a method of FIG. 6 may be adopted. In this case, if a corresponding cell includes only one terminal, the method of FIG. 4 may be applied.

In operation 434, the TSCTSF or the 5GS sync NF may transmit the 5GS sync status to the AF.

In operation 436, the UE may set up the PDU session, and the SMF may identify UDM subscription information with respect to the sync serviceability. Operation 436 may precede operation 410. In this case, operation 442 may be performed after operation 436.

If the sync accuracy level or the time error budget provided by the 5GS in operation 442, operation 452 and operation 462 is changed, the TSCTSF/NEF may transmit specific terminal information and sync error budget information of the corresponding terminal to the RAN node (or the gNB) via the PCF and the AMF. The RAN node may increase or decrease a system information block (SIB) period based on the sync error budget information provided from the 5GC, or increase or decrease a latency measurement period between the base station and the terminal to measure a timing advance value of each terminal. Hence, the RAN node may control to satisfy the sync accuracy requirement of the terminal.

In operation 442, if the sync accuracy setup request information is changed, the TSCTSF or the 5GS sync NF may transmit a request to notify the change (e.g., Npcf_Authorization)to the UDM/UDR. If the sync accuracy setup request information is changed, the UDR may request the sync accuracy setup from the PCF. Also, the UDR may notify the TSCTSF of the sync accuracy setup request information change. At this time, the request (e.g., Npcf_Authorization) to notify the sync accuracy setup request information change may include the sync error budget.

In operation 452, the PCF may transmit to the AMF a policy information change message (e.g., Npcf_AM_PolicyControl_UpdateNotify) including the sync accuracy requirement such as sync error budget.

In operation 462, the AMF may transmit a policy update request (e.g., notify UE about PCF update) to the gNB. The gNB may increase or decrease the SIB period based on the received sync accuracy requirement such as sync error budget, or increase or decrease the latency measurement period between the base station and the terminal to measure the timing advance value of each terminal. At this time, the policy update request (e.g., notify UE about PCF update) of the gNB may include the sync error budget.

In operation 440, operation 450, operation 460, and operation 470, the TSCTSF or the 5GS sync NF may transmit the 5GS sync status to the corresponding UE. In so doing, the PCF, the SMF, the AMF, or the gNB may, if necessary, manage signaling through a timer related to the 5GS sync status.

In operation 440, the TSCTSF or the 5GS sync NF may forward the 5GS sync status to the PCF, using an association (e.g., Npcf_Authorization) established by setting the PDU session of the corresponding terminal.

In operation 450, the PCF may forward the 5GS sync status to the SMF, using an association (e.g., Npcf_SM_PolicyControl_UpdateNotify) established by setting the PDU session of the corresponding terminal.

In operation 460, the SMF may forward the 5GS sync status information to the AMF, to deliver the 5GS sync status to the terminal.

In operation 470, if the AMF forwards the 5GS sync status information to the terminal, the terminal may identify whether the 5GS satisfies the sync accuracy requested by the terminal, and perform adjustment based on the current sync status. For example, the terminal may modify an application operation, by reflecting the difference from the UTC.

After operation 460, if the terminal enters an idle mode, the corresponding terminal may be paged in operation 462 and then operation 470 may be performed.

The AF may forward the 5GS sync status to the UE using the user plane in operation 480. The UEmay confirm the 5GS sync status at the AF using the user plane in operation 482. Operation 480 or operation 482 may be omitted.

Through the signaling shown in FIG. 4, the 5GS may determine whether the UE requirement is satisfied based on the subscription information and the coverage condition. That is, the 5GS may determine whether to deliver the sync status to the terminal and the AF. Hence, the 5GS may deliver the sync status or the 5GS sync status to the terminal using the SM NAS signaling, and to the AF using the CP.

FIG. 5 illustrates an example in which a 5GC delivers a sync status to a terminal via AM NAS signaling, and to an AF via a CP according to embodiments of the disclosure.

Description on network entities and NFs of FIG. 5 may apply the descriptions of FIG. 1A through FIG. 3B. Accordingly, redundant description thereof shall be omitted. FIG. 5 illustrates that the UE includes the DS-TT, but the disclosure is not limited thereto. That is, the UE may be connected to the DS-TT as shown in FIG. 3A. A TSCTSF and A NEF may be independently configured as separate NFs, or may be configured as one NF. A 5GS sync NF to be described may indicate an NF for performing specific function and operation.

The signaling example of FIG. 5 may be used if each terminal establishes a plurality of PDU sessions and the PDU sessions utilize the 5GS sync service. However, the embodiment of FIG. 5 may relatively reduce signaling. However, the embodiment of FIG. 5 is not applied only to the above situation, and the embodiment is merely to facilitate the explanation. In addition, the embodiment of FIG. 5 may include redundant operations of FIG. 4, and description thereof shall be omitted.

In operation 500, the terminal may transmit a requirement related to time sync accuracy to the 5GC through 5GS registration. The 5GC may identify subscription information of whether the terminal may receive the sync service. If identifying the subscription information, the 5GC may further store details of the subscription information in the UDM.

In operation 510, the AF may request the 5GC to provide the synchronization service to the terminal. For example, the AF may request a 5GS synchronization service from the TSCTSF/NEF. At this time, the AF may designate a condition of the terminal. For example, the AF may provide information for the UE registration with respect to an identifier (e.g., a UE ID, a UE group ID, etc.) such as a GPSI of the terminal. Also, the AF may provide information for PDU session setup such as DNN/S-NSSAI. Further, the AF may provide a coverage condition. Herein, the coverage condition may indicate geographical location information (or location information). Herein, the center coordinates may indicate a latitude and a longitude of the AF, and the radius may indicate a coverage range required by the AF. Alternatively, the center coordinates may indicate a location of the gNB, and the radius may indicate coverage serviceable by the gNB. The coverage condition may be preset in a service provider network. In this case, operation 510 may be omitted.

The NEF may change the geographic location information to coordinates and the radius. Alternatively, the location information may be expressed based on a cell ID. The UE ID received as the GPSI may be changed to an ID such as SUPI used only inside the 5GS. Changing the TSCTSF or a separate 5GS sync NF may be performed inside the 5GC.

If operation 510 precedes operation 500, the AF may provide information of the UE registration with respect to the identifier (e.g., a UE ID, a UE group ID, etc.) such as GPSI of the terminal. Also, the AF may provide information of the PDU session setup such as DNN/S-NSSAI. Further, the information such as DNN/S-NSSAI may be stored in the UDR. If identifying terminal registration satisfying a specific condition in operation 500, the UDR may notify this to the TSCTSF to perform from operation 520.

In operation 520, the TSCTSF or the 5GS sync NF may transmit to the AMF a request to notify a terminal identified to match based on the location information. For example, the TSCTSF or the NEF may transmit subscription information including the location information and the range to the AMF. Hence, the AMF, upon receiving the subscription information, may identify the request to notify the terminal identified to match based on the subscription information.

In operation 530, the AMF may notify terminals identified based on the location information to the TSCTSF or the 5GS sync NF.

In operation 532, the TSCTSF or the 5GS sync NF may identify the coverage condition, and identify a 5GS sync status based on the coverage condition. At this time, the 5GS may have a plurality of sync sources, and the current sync status may differ depending on the sync source. For example, if the 5GS uses a first timing source and the reference UTC indicates 1 hour 00 minute 00 second, the 5GS absolute time may indicate 1 hour 00 minute 01 second. That is, a different (error) of 1 second may occur every one hour between the 5GS absolute time and the UTC. In this case, information of the 1-second error based on 1 hour may be the sync status. By contrast, if the 5GS uses a second timing source and the UTC indicates 1 hour 00 minute 00 second, the 5GS absolute time may indicate 1 hour 00 minute 0.5 second. That is, a different (error) of 1 second may occur every one hour between the 5GS absolute time and the UTC. In this case, information of the 1-second error based on 1 hour may be the sync status.

In operation 532, the TSCTSF or the 5GS sync NF may identify whether the UE requirement is satisfied, by considering time sync accuracy required by the terminal and a current time sync status provided by the 5GS. If satisfying the terminal requirement, the 5GS may perform internal setup to provide the sync accuracy to the terminal. The 5GS may determine whether to deliver the 5GS sync status to the UE and the AF. In addition, the 5GS sync status is changed, operation 532 may be performed.

The 5GS may select a method for delivering the sync status to the UE or the AF. That is, if only one PDU session is established at one terminal, the method of FIG. 4 may be applied. In this case, if a plurality of PDU sessions is identified at the terminal, the method of FIG. 5 may be applied. Alternatively, if it is necessary to deliver the 5GS sync status to a plurality of terminals of one cell, a method of FIG. 6 may be adopted. In this case, if a corresponding cell includes only one terminal, the method of FIG. 5 may be applied.

In operation 534, the TSCTSF or the 5GS sync NF may forward the 5GS sync status to the AF.

In operation 536, the UE may set up the PDU session, and the SMF may identify subscription information of the UDM with respect to the sync serviceability. Operation 536 may precede operation 510. In this case, operation 542 may be performed after operation 536. Operation 536 may be omitted.

If a sync accuracy level or a time error budget provided by the 5GS in operation 542, operation 552 and operation 562 is changed, the TSCTSF/NEF may transmit specific terminal information and sync error budget information of the corresponding terminal to the RAN node (or the gNB) via the PCF and the AMF. The RAN node may increase or decrease a SIB period based on the sync error budget information provided from the 5GC, or increase or decrease a latency measurement period between the base station and the terminal to measure a timing advance value of each terminal. Hence, the RAN node may control to satisfy the sync accuracy requirement of the UE.

In operation 542, if sync accuracy setup request information is changed, the TSCTSF or the 5GS sync NF may transmit a request to notify the change (e.g., Npcf_Authorization)to the UDM/UDR. If the sync accuracy setup request information is changed, the UDR may request the sync accuracy setup from the PCF. Also, the UDR may notify the TSCTSF of the sync accuracy setup request information change.

In operation 552, the PCF may transmit to the AMF a policy information change message (e.g., Npcf_AM_PolicyControl_UpdateNotify) including the sync accuracy requirement such as sync error budget.

In operation 562, the AMF may transmit a policy update request (e.g., Notify UE about PCF update) to the gNB. The gNB may increase or decrease the SIB period based on the received sync accuracy requirement such as sync error budget, or increase or decrease the latency measurement period between the base station and the terminal to measure the timing advance value of each terminal.

In operation 540, operation 550 and operation 560, the TSCTSF or the 5GS sync NF may forward the 5GS sync status to the corresponding UE.

In operation 540, the TSCTSF or the 5GS sync NF may transmit to the UDM/UDR a request (e.g., Npcf_Authorization) to notify a change of the sync accuracy setup request information. If the sync accuracy setup request information is changed, the UDR may request the sync accuracy setup from the PCF. Also, the UDR may notify the TSCTSF of the sync accuracy setup request information change.

In operation 550, the PCF may forward 5GS sync status information to the AMF, to deliver the 5GS sync status to the terminal.

In operation 560, if the AMF forwards the 5GS sync status information to the terminal, the terminal may identify whether the 5GS satisfies the sync accuracy requested by the terminal, and perform adjustment based on the current sync status. For example, the terminal may modify an application operation, by reflecting a difference from the UTC.

After operation 550, if the terminal enters an idle mode, the corresponding terminal may be paged in operation 542 and then operation 560 may be performed.

The AF may forward the 5GS status to the UE using the user plane in operation 570. The UE may confirm the 5GS status at the AF using the user plane in operation 572. Operation 570 or operation 572 may be omitted.

Through the signaling shown in FIG. 5, the 5GS may determine whether the terminal requirement is satisfied based on the subscription information and the coverage condition. That is, the 5GS may determine whether to deliver the sync status to the terminal and the AF. Hence, the 5GS may deliver the sync status or the 5GS sync status to the terminal using the AM NAS signaling, and to the AF using the CP.

FIG. 6 illustrates an example in which a 5GC delivers a sync status to a terminal via AS (SIB, RRC signaling) signaling, and to an AF via a CP according to embodiments of the disclosure.

Description on network entities and NFs of FIG. 6 may apply the same descriptions as FIG. 1A through FIG. 3B. Accordingly, redundant description thereof shall be omitted. FIG. 6 illustrates that the UE includes the D S-TT, but the disclosure is not limited thereto. That is, the UE may be connected to the DS-TT as shown in FIG. 3A. The TSCTSF and the NEF may be independently configured as separate NFs, or may be configured as one NF. A 5GS sync NF to be described may indicate an NF for performing specific function and operation. In addition, the embodiment of FIG. 6 may include redundant operations of FIG. 4, and description thereof shall be omitted.

The signaling example of FIG. 6 is advantageous if the same 5GS sync status is to be delivered to a plurality of terminals of a specific cell. In particular, if a plurality of terminals is in an RRC inactive or idle state, the sync status may be delivered merely via signaling between the base station and the terminals and accordingly signaling overhead may be reduced. However, the embodiment of FIG. 6 is not applied only to the above situation, and the embodiment is merely to facilitate the explanation.

In operation 600, the terminal may transmit a requirement related to time sync accuracy to the 5GC through 5GS registration. The 5GC may identify subscription information of whether the terminal may receive the sync service. If identifying the subscription information, the 5GC may further store details of the subscription information in the UDM.

In operation 610, the AF may request the 5GC to provide the synchronization service to the terminal. For example, the AF may request a 5GS synchronization service from the TSCTSF/NEF. At this time, the AF may designate a condition of the terminal. For example, the AF may provide information for the UE registration with respect to an identifier (e.g., a UE ID, a UE group ID, etc.) such as GPSI of the terminal. Also, the AF may provide information for PDU session setup such as DNN/S-NSSAI. In addition, the AF may provide a coverage condition. Herein, the coverage condition may indicate geographical location information (or location information). Herein, the center coordinates may indicate a latitude and a longitude of the AF, and the radius may indicate a coverage range required by the AF. Alternatively, the center coordinates may indicate a location of the gNB, and the radius may indicate coverage serviceable by the gNB. The coverage condition may be preset in a service provider network. In this case, operation 610 may be omitted.

The NEF may change the geographic location information to the coordinates and the radius. Alternatively, the location information may be expressed based on a cell ID. The UE ID received as the GPSI may be changed to an ID such as SUPI used only inside the 5GS. Changing the TSCTSF or a separate 5GS sync NF may be performed inside the 5GC.

If operation 610 precedes operation 600, the AF may provide information of the UE registration with respect to the identifier (e.g., a UE ID, a UE group ID, etc.) such as terminal GPSI. Also, the AF may provide information of the PDU session setup such as DNN/S-NSSAI. The information such as DNN/S-NSSAI may be stored in the UDR. If identifying terminal registration satisfying a specific condition in operation 600, the UDR may notify this to the TSCTSF to perform from operation 620.

In operation 620, the TSCTSF or the 5GS sync NF may transmit to the AMF a request to notify a terminal identified to match based on the location information. For example, the TSCTSF or the NEF may transmit subscription information including the location information and the range to the AMF. Hence, the AMF, upon receiving the subscription information, may identify the request to notify of the terminal identified to match based on the subscription information.

In operation 630, the AMF may notify terminals matched based on the location information to the TSCTSF or the 5GS sync NF.

In operation 632, the TSCTSF or the 5GS sync NF may identify the coverage condition, and identify a 5GS sync status based on the coverage condition. At this time, the 5GS may have a plurality of sync sources, and the current sync status may differ depending on the sync source. For example, if the 5GS uses a first timing source and the reference UTC indicates 1 hour 00 minute 00 second, the absolute time of the 5GS may indicate 1 hour 00 minute 01 second. That is, a different (error) of 1 second may occur every one hour between the 5GS absolute time and the UTC. In this case, information of the 1-second error based on 1 hour may be the sync status. By contrast, if the 5GS uses a second timing source and the reference UTC indicates 1 hour 00 minute 00 second, the 5GS absolute time may indicate 1 hour 00 minute 0.5 second. That is, a different (error) of 1 second may occur every one hour between the 5GS absolute time and the UTC. In this case, information of the 1-second error based on 1 hour may be the sync status.

In operation 632, the TSCTSF or the 5GS sync NF may identify whether the terminal requirement is satisfied, by considering time sync accuracy required by the terminal and a current time sync status provided by the 5GS. If satisfying the terminal requirement, the 5GS may perform internal setup to provide the sync accuracy to the terminal. The 5GS may determine whether to deliver the 5GS sync status to the UE and the AF. If the 5GS sync status is changed, operation 632 may be performed.

The 5GS may select a method for delivering the sync status to the UE or the AF. That is, if the 5GS sync status is delivered to one terminal of one cell, the method of FIG. 4 or FIG. 5 may be applied. In this case, if it is necessary to deliver the 5GS sync status to a plurality of terminals, the method of FIG. 6 may be adopted.

In operation 634, the TSCTSF or the 5GS sync NF may forward the 5GS sync status to the AF.

In operation 636, the UE may set up the PDU session, and the SMF may identify UDM subscription information with respect to the sync serviceability. Operation 636 may precede operation 610. In this case, operation 642 may be performed after operation 636. Operation 636 may be omitted.

If a sync accuracy level or a time error budget provided by the 5GS in operation 642, operation 652 and operation 662 is changed, the TSCTSF/NEF may forward specific terminal information and sync error budget information of the corresponding terminal to the RAN node (or the gNB) via the PCF and the AMF. The RAN node may increase or decrease a SIB period based on the sync error budget information provided from the 5GC, or increase or decrease a latency measurement period between the base station and the terminal to measure a timing advance value of each terminal. Hence, the RAN node may control to satisfy the sync accuracy requirement of the terminal.

In operation 642, if sync accuracy setup request information is changed, the TSCTSF or the 5GS sync NF may transmit a request to notify the change (e.g., Npcf_Authorization)to the UDM/UDR. If the sync accuracy setup request information is changed, the UDR may request the sync accuracy setup from the PCF. Also, the UDR may notify the TSCTSF of the sync accuracy setup request information change.

In operation 652, the PCF may transmit to the AMF a policy information change message (e.g., Npcf_AM_PolicyControl_UpdateNotify) including the sync accuracy requirement such as sync error budget.

In operation 662, the AMF may transmit a policy update request (e.g., Notify UE about PCF update) to the gNB. The gNB may increase or decrease the SIB period based on the received sync accuracy requirement such as sync error budget, or increase or decrease the latency measurement period between the base station and the terminal to measure the timing advance value of each terminal.

In operation 640, operation 650, operation 660 and operation 670, the TSCTSF or the 5GS sync NF may deliver the 5GS sync status to the corresponding UE.

In operation 640, the TSCTSF or the 5GS sync NF may transmit to the UDM/UDR a request (e.g., Npcf_Authorization) to notify a change of the sync accuracy setup request information. If the sync accuracy setup request information is changed, the UDR may request the sync accuracy setup from the PCF. Also, the UDR may notify the TSCTSF of the sync accuracy setup request information change.

In operation 650, the PCF may forward 5GS sync status information to the AMF, to deliver the 5GS sync status to the terminal.

In operation 660, the AMF may transmit a policy update request to the gNB. The gNB may increase or decrease the SIB period based on the received sync accuracy requirement such as sync error budget. Also, the gNB may increase or decrease the latency measurement period between the base station and the terminal to measure the timing advance value of each terminal.

In operation 670, the gNB may forward the sync status to the terminal using the AS (e.g., SIB, RRC signaling). In an embodiment, the base station may periodically forward the sync status to a plurality of terminals, by broadcasting the SIB including the sync status to the plurality of the terminals of a specific cell. In an embodiment, the plurality of the terminals may switch to an RRC connected state through the SIB broadcast by the base station. The plurality of the terminals may receive a higher layer message (e.g., an RRC message) including the sync status from the base station. If receiving the 5GS sync status, the terminal may identify whether the 5GS satisfies the sync accuracy requested by the terminal, and perform adjustment based on the current sync status. For example, the terminal may modify an application operation, by reflecting a difference from the UTC.

The AF may forward the 5GS status to the UE using the user plane in operation 680. The UE may confirm the 5GS status at the AF using the user plane in operation 682. Operation 680 or operation 682 may be omitted.

Through the signaling shown in FIG. 6, the 5GS may determine whether the terminal requirement is satisfied based on the subscription information and the coverage condition. That is, the 5GS may determine whether to deliver the sync status to the terminal and the AF. Hence, the 5GS may deliver the sync status or the 5GS sync status to the terminal using the AS signaling, and to the AF using the CP.

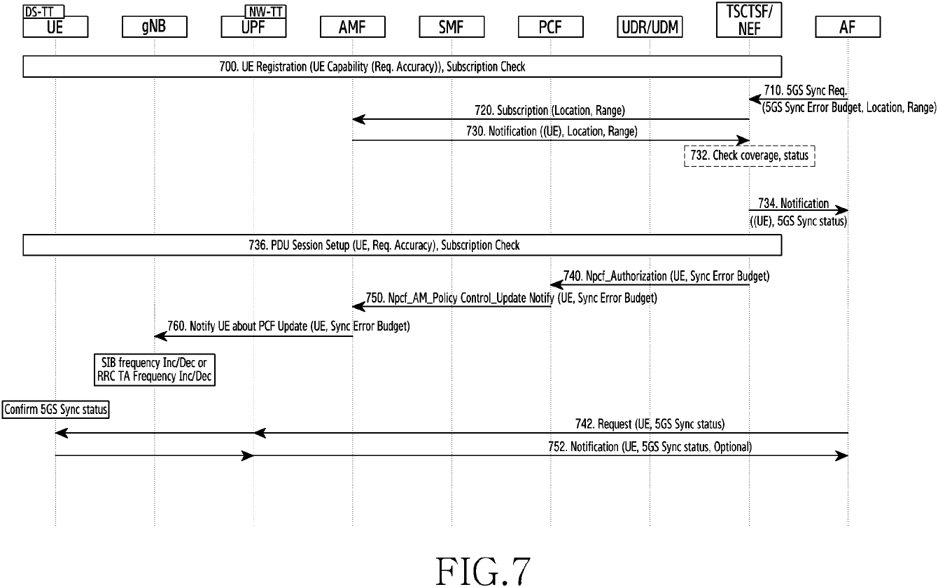

FIG. 7 illustrates an example in which a 5GC notifies a sync status to an AF, and the AF forwards the sync status to a terminal via a UP according to embodiments of the disclosure.

Description on network entities and NFs of FIG. 7 may apply the same descriptions as FIG. 1A through FIG. 3B. Accordingly, detailed description thereof shall be omitted. FIG. 7 illustrates that the UE includes the D S-TT, but the disclosure is not limited thereto. That is, the UE may be connected to the DS-TT as shown in FIG. 3A. The TSCTSF and the NEF may be independently configured as separate NFs, or may be configured as one NF. A 5GS sync NF to be described may indicate an NF for performing specific function and operation. In addition, the embodiment of FIG. 7 may include redundant operations of FIG. 4, and description thereof shall be omitted.

The signaling example of FIG. 7 may be used if it is necessary to minimize CP change. However, the embodiment of FIG. 7 is not applied only to the above situation, and the above example is merely to facilitate the explanation.

In operation 700, the terminal may transmit a requirement related to time sync accuracy to the 5GC through 5GS registration. The 5GC may identify subscription information of whether the terminal may receive the sync service. If identifying the subscription information, the 5GC may further store details of the subscription information in the UDM.

In operation 710, the AF may request the 5GC to provide the synchronization service to the terminal. For example, the AF may request a 5GS synchronization service from the TSCTSF/NEF. At this time, the AF may designate a condition of the terminal. For example, the AF may provide information for the UE registration with respect to an identifier (e.g., a UE ID, a UE group ID, etc.) such as GPSI of the terminal. Also, the AF may provide information for PDU session setup such as DNN/S-NSSAI. Further, the AF may provide a coverage condition. Herein, the coverage condition may indicate geographical location information (or location information). Herein, center coordinates may indicate a latitude and a longitude of the AF, and a radius may indicate a coverage range required by the AF. Alternatively, the center coordinates may indicate a location of the gNB, and the radius may indicate coverage serviceable by the gNB. The coverage condition may be preset in a service provider network. In this case, operation 710 may be omitted.

The NEF may change the geographic location information to the coordinates and the radius. Alternatively, the location information may be expressed based on a cell ID. The UE ID received as the GPSI may be changed to an ID such as SUPI used only inside the 5GS. Changing the TSCTSF or a separate 5GS sync NF may be performed inside the 5GC.

If operation 710 precedes operation 700, the AF may provide information of the UE registration with respect to the identifier (e.g., a UE ID, a UE group ID, etc.) such as GPSI of the terminal. Also, the AF may provide information of the PDU session setup such as DNN/S-NSSAI. The information such as DNN/S-NSSAI may be stored in the UDR. If identifying terminal registration satisfying a specific condition in operation 700, the UDR may notify this to the TSCTSF to perform from operation 720.

In operation 720, the TSCTSF or the 5GS sync NF may transmit to the AMF a request to notify a terminal identified to match based on the location information. For example, the TSCTSF or the NEF may transmit subscription information including the location information and the range to the AMF. Hence, the AMF, upon receiving the subscription information, may identify the request to notify the terminal identified to match based on the subscription information.

In operation 730, the AMF may notify terminals matched based on the location information to the TSCTSF or the 5GS sync NF.

In operation 732, the TSCTSF or the 5GS sync NF may identify the coverage condition, and identify a 5GS sync status based on the coverage condition. At this time, the 5GS may have a plurality of sync sources, and the current sync status may differ depending on the sync source. For example, if the 5GS uses a first timing source and the reference UTC indicates 1 hour 00 minute 00 second, the 5GS absolute time may indicate 1 hour 00 minute 01 second. That is, a different (error) of 1 second may occur every one hour between the 5GS absolute time and the UTC. In this case, information of the 1-second error based on 1 hour may be the sync status. By contrast, if the 5GS uses a second timing source and the reference UTC indicates 1 hour 00 minute 00 second, the 5GS absolute time may indicate 1 hour 00 minute 0.5 second. That is, a different (error) of 1 second may occur every one hour between the 5GS absolute time and the UTC. In this case, information of the 1-second error based on 1 hour may be the sync status.

In operation 732, the TSCTSF or the 5GS sync NF may identify whether the terminal requirement is satisfied, by considering a required time sync accuracy by the terminal and a current time sync status provided by the 5GS. If satisfying the terminal requirement, the 5GS may perform internal setup to provide the sync accuracy to the terminal. The 5GS may determine whether to deliver the 5GS sync status to the UE and the AF. In addition, the 5GS sync status is changed, operation 732 may be performed.

In operation 734, the TSCTSF or the 5GS sync NF may forward the 5GS sync status to the AF.

In operation 736, the UE may set up the PDU session, and the SMF may identify UDM subscription information with respect to the sync serviceability. Operation 736 may precede operation 710. In this case, operation 740 may be performed after operation 736.

If a sync accuracy level or a time error budget provided by the 5GS in operation 740, operation 750 and operation 760 is changed, the TSCTSF/NEF may forward specific terminal information and sync error budget information of the corresponding terminal to the RAN node (or the gNB) via the PCF and the AMF. The RAN node may increase or decrease a SIB period based on the sync error budget information provided from the 5GC, or increase or decrease a latency measurement period between the base station and the terminal to measure a timing advance value of each terminal. Hence, the RAN node may control to satisfy the sync accuracy requirement of the terminal.

In operation 740, the TSCTSF or the 5GS sync NF may transmit a request (e.g., Npcf_Authorization) to notify if sync accuracy setup request information is changed to the UDM/UDR. If the sync accuracy setup request information is changed, the UDR may request the sync accuracy setup from the PCF. Also, the UDR may notify the TSCTSF of the sync accuracy setup request information change.

In operation 750, the PCF may transmit to the AMF a policy information change message (e.g., Npcf_AM_PolicyControl_UpdateNotify) including the sync accuracy requirement such as sync error budget.

In operation 760, the AMF may transmit a policy update request (e.g., notify UE about PCF update) to the gNB. The gNB may increase or decrease the SIB period based on the received sync accuracy requirement such as sync error budget, or increase or decrease the latency measurement period between the base station and the terminal to measure the timing advance value of each terminal.

In operation 742, the AF may forward the 5GS sync status to the UE using the user plane. If receiving the 5GS sync status, the corresponding terminal may identify whether the 5GS satisfies the sync accuracy requested by the terminal, and perform adjustment based on the current sync status. For example, the terminal may modify an application operation, by reflecting the difference from the UTC.

In operation 752, the UE may confirm the 5GS sync status at the AF using the user plane. Operation 752 may be omitted.

Through the signaling shown in FIG. 7, the 5GS may determine whether the terminal requirement is satisfied based on the subscription information and the coverage condition. That is, the 5GS may determine whether to deliver the sync status to the UE and the AF. Hence, the 5GS may notify the sync status or the 5GS sync status to the AF, and the AF may forward the 5GS sync status to the terminal using the UP.

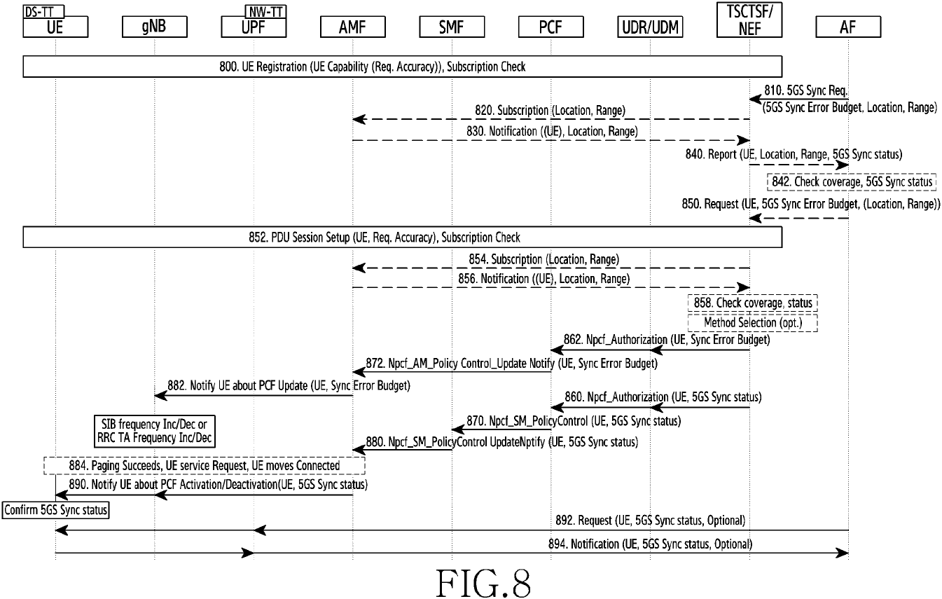

FIG. 8 illustrates an example in which a 5GC notifies a sync status to an AF, and the 5GC transmits SM NAS signaling to a terminal at a request of the AF according to embodiments of the disclosure.

Description on network entities and NFs of FIG. 8 may apply the same descriptions as FIG. 1A through FIG. 3B. Accordingly, detailed description thereof shall be omitted. FIG. 8 illustrates that the UE includes the D S-TT, but the disclosure is not limited thereto. That is, the UE may be connected to the DS-TT as shown in FIG. 3A. The TSCTSF and the NEF may be independently configured as separate NFs, or may be configured as one NF. A 5GS sync NF to be described may indicate an NF for performing specific function and operation. In addition, the embodiment of FIG. 8 may include redundant operations of FIG. 4, and redundant description thereof shall be omitted.

The signaling example of FIG. 8 may be utilized if the UE establishes a plurality of PDU sessions and uses a sync service only in a particular one of the PDU sessions. However, the embodiment of FIG. 8 is not applied only to the above situation, and the above example is merely to facilitate the explanation.

In operation 800, the terminal may transmit a requirement related to time sync accuracy to the 5GC through 5GS registration. The 5GC may identify subscription information of whether the terminal may receive the sync service. If identifying the subscription information, the 5GC may further store details of the subscription information in the UDM.

In operation 810, the AF may request the 5GC to provide the synchronization service to the terminal. For example, the AF may request a 5GS synchronization service from the TSCTSF/NEF. At this time, the AF may designate a condition of the terminal. For example, the AF may provide information for the UE registration with respect to an identifier (e.g., a UE ID, a UE group ID, etc.) such as GPSI of the terminal. Also, the AF may provide information for PDU session setup such as DNN/S-NSSAI. In addition, the AF may provide a coverage condition. Herein, the coverage condition may indicate geographical location information (or location information). Herein, center coordinates may indicate a latitude and a longitude of the AF, and a radius may indicate a coverage range required by the AF. Alternatively, the center coordinates may indicate a location of the gNB, and the radius may indicate coverage serviceable by the gNB. The coverage condition may be preset in a service provider network. In this case, operation 810 may be omitted.

The NEF may change the geographic location information to the coordinates and the radius. Alternatively, the location information may be expressed based on a cell ID. The UE ID received as the GPSI may be changed to an ID such as SUPI used only inside the 5GS. Changing the TSCTSF or a separate 5GS sync NF may be performed inside the 5GC.

If operation 810 precedes operation 800, the AF may provide information of the UE registration with respect to the identifier (e.g., a UE ID, a UE group ID, etc.) such as GPSI of the terminal. Also, the AF may provide information of the PDU session setup such as DNN/S-NSSAI. The information such as DNN/S-NS SAI may be stored in the UDR. If identifying terminal registration satisfying a specific condition in operation 800, the UDR may notify this to the TSCTSF to perform from operation 820.

In operation 820, the TSCTSF or the 5GS sync NF may transmit to the AMF a request to notify of a terminal identified to match based on the location information. For example, the TSCTSF or the NEF may transmit subscription information including the location information and the range to the AMF. Hence, the AMF, upon receiving the subscription information, may identify the request to notify of the terminal identified to match based on the subscription information.

In operation 830, the AMF may notify terminals matched based on the location information to the TSCTSF or the 5GS sync NF.

In so doing, the TSCTSF or the 5GS sync NF may obtain the 5GS sync status. The 5GS may have a plurality of sync sources, and the current sync status may differ depending on the sync source. For example, if the 5GS uses a first timing source and the reference UTC indicates 1 hour 00 minute 00 second, the absolute time of the 5GS may indicate 1 hour 00 minute 01 second. That is, a different (error) of 1 second may occur every one hour between the 5GS absolute time and the UTC. In this case, information of the 1-second error based on 1 hour may be the sync status. By contrast, if the 5GS uses a second timing source and the reference UTC indicates 1 hour 00 minute 00 second, the 5GS absolute time may indicate 1 hour 00 minute 0.5 second. That is, a different (error) of 1 second may occur every one hour between the 5GS absolute time and the UTC. In this case, information of the 1-second error based on 1 hour may be the sync status.

In operation 840, the TSCTSF or the 5GS sync NF may forward the 5GS sync status and/or the coverage condition to the AF. That is, the TSCTSF or the 5GS sync NF may report the 5GS sync status and/or the coverage condition to the AF.

In operation 842, the AF may identify the coverage condition. The AF may identify the 5GS sync status. By identifying the two conditions, the AF may identify whether the terminal requirement is satisfied. If satisfying the terminal requirement, the 5GS may perform internal setup to provide the sync accuracy to the corresponding terminal, and the AF may determine to request the 5GS to provide the synchronization service to the terminal.

In operation 850, the AF may request the 5GS to internally set up to provide the sync accuracy to the corresponding terminal and request the TSCTSF or the 5GS sync NF to provide the synchronization service to the terminal.

In operation 852, the UE may establish the PDU session, and the SMF may identify UDM subscription information with respect to the sync serviceability. Operation 852 may precede operation 810. In this case, operation 854 may be performed after operation 850.

In operation 854, the TSCTSF or the 5GS sync NF may request the AFM to notify a terminal matched based on the location information. Operation 854 may be omitted.

In operation 856, the AMF may notify the TSCTSF or the 5GS sync NF of terminals matched based on the location information. Operation 856 may be omitted.

In operation 858, the TSCTSF or the 5GS sync NF may identify whether the terminal requirement is satisfied, by considering time sync accuracy required by the terminal and a current time sync status provided by the 5GS. If satisfying the terminal requirement, the 5GS may perform internal setup to provide the sync accuracy to the corresponding terminal. The 5GS may determine whether to forward the 5GS sync status to the UE. In addition, if the 5GS sync status is changed, operation 858 may be performed.

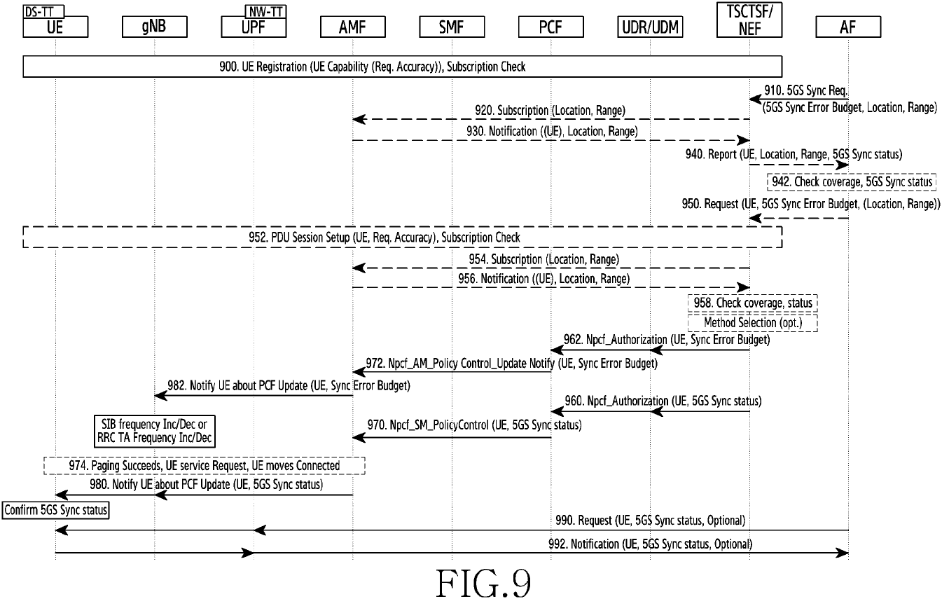

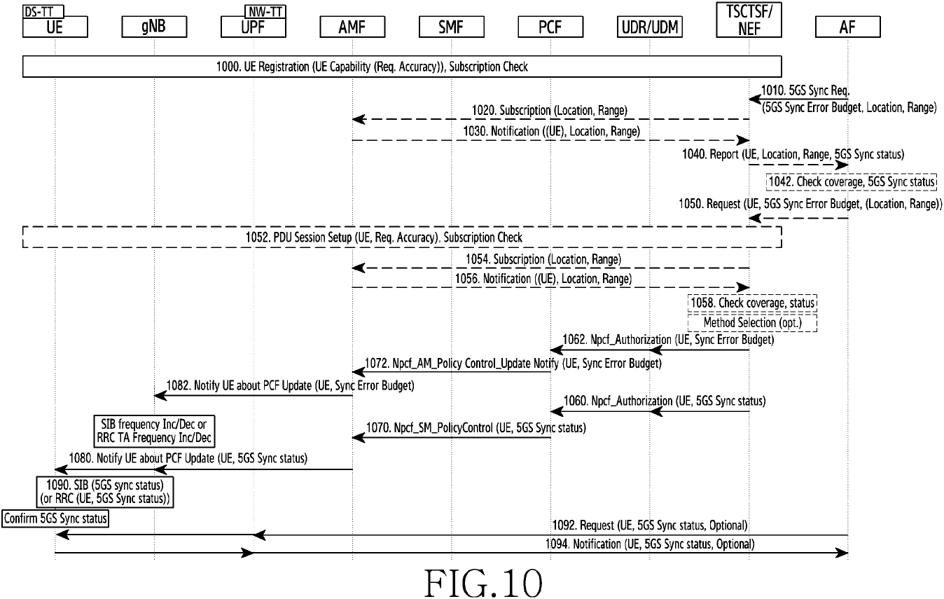

The 5GS may select a method for delivering the sync status to the UE or the AF. That is, since a plurality of PDU sessions may be established at one terminal, a method of FIG. 10 may be applied. In this case, if only one of the plurality of the PDU sessions is identified at the terminal, the method of FIG. 8 may be applied. Alternatively, if it is necessary to deliver the 5GS sync status to a plurality of terminals of one cell, a method of FIG. 9 may be adopted. In this case, if a corresponding cell includes only one terminal, the method of FIG. 8 may be applied.

If a sync accuracy level or a time error budget provided by the 5GS in operation 862, operation 872 and operation 882 is changed, the TSCTSF/NEF may forward specific terminal information and sync error budget information of the corresponding terminal to the RAN node (or the gNB) via the PCF and the AMF. The RAN node may increase or decrease a SIB period based on the sync error budget information provided from the 5GC, or increase or decrease a latency measurement period between the base station and the terminal to measure a timing advance value of each terminal. Hence, the RAN node may control to satisfy the sync accuracy requirement of the terminal.

In operation 862, the TSCTSF or the 5GS sync NF may transmit to the UDM/UDR a request (e.g., Npcf_Authorization) to notify if sync accuracy setup request information is changed. If the sync accuracy setup request information is changed, the UDR may request the sync accuracy setup from the PCF. Also, the UDR may notify the TSCTSF of the sync accuracy setup request information change.

In operation 872, the PCF may transmit to the AMF a policy information change message (e.g., Npcf_AM_PolicyControl_UpdateNotify) including the sync accuracy requirement such as sync error budget.

In operation 882, the AMF may transmit a policy update request (e.g., Notify UE about PCF update) to the gNB. The gNB may increase or decrease the SIB period based on the received sync accuracy requirement such as sync error budget, or increase or decrease the latency measurement period between the base station and the terminal to measure the timing advance value of each terminal.

In operation 860, operation 870, operation 880, and operation 890, the TSCTSF or the 5GS sync NF may deliver the 5GS sync status to the corresponding UE. At this time, the PCF, the SMF, the AMF, or the gNB may, if necessary, manage signaling through a timer related to the 5GS sync status.

In operation 860, the TSCTSF or the 5GS sync NF may forward the 5GS sync status to the PCF, using an association (e.g., Npcf_Authorization) established by setting the PDU session of the corresponding terminal.

In operation 870, the PCF may forward the 5GS sync status to the SMF, using an association (e.g., Npcf_SM_PolicyControl_UpdateNotify) established by setting the PDU session of the corresponding terminal.

In operation 880, the SMF may forward the 5GS sync status information to the AMF, to deliver the 5GS sync status to the terminal.

In operation 890, if the AMF forwards the 5GS sync status information to the terminal, the terminal may identify whether the 5GS satisfies the sync accuracy requested by the terminal, and perform adjustment based on the current sync status. For example, the terminal may modify an application operation, by reflecting the difference from the UTC.

After operation 880, if the terminal enters the idle mode, the corresponding terminal may be paged in operation 884 and then operation 890 may be performed.

The AF may forward the 5GS status to the UE using the user plane in operation 892. The UE may confirm the 5GS status at the AF using the user plane in operation 894. Operation 892 or operation 894 may be omitted.

Through the signaling shown in FIG. 8, the 5GS may notify the sync status to the AF. Hence, the AF may request the 5GS (e.g., the TSCTSF or the 5GS sync NF) to deliver the sync status or the 5GS sync status to the terminal. The 5GS receiving the request from the AF may deliver the sync status information to the terminal using SM NAS signaling.

FIG. 9 illustrates an example in which a 5GC notifies a sync status to an AF, and the 5GC transmits AM NAS signaling to a terminal at a request of the AF according to embodiments of the disclosure.

Description on network entities and NFs of FIG. 9 may apply the same descriptions of FIG. 1A through FIG. 3B. Accordingly, detailed description thereof shall be omitted. FIG. 9 illustrates that the UE includes the DS-TT, but the disclosure is not limited thereto. That is, the UE may be connected to the DS-TT as shown in FIG. 3A. The TSCTSF and the NEF may be independently configured as separate NFs, or may be configured as one NF. A 5GS sync NF to be described may indicate an NF for performing specific function and operation. In addition, the embodiment of FIG. 9 may include redundant operations of FIG. 4, and description thereof shall be omitted.

The signaling example of FIG. 9 may be used if a plurality of PDU sessions is established at each terminal and the PDU sessions utilize the 5GS sync service. The embodiment of FIG. 9 may relatively reduce signaling. However, the embodiment of FIG. 9 is not applied only to the above situation, and the example is merely to facilitate the explanation.

In operation 900, the terminal may transmit a requirement related to time sync accuracy to the 5GC through 5GS registration. The 5GC may identify subscription information of whether the terminal may receive the sync service. If identifying the subscription information, the 5GC may further store details of the subscription information in the UDM.

In operation 910, the AF may request the 5GC to provide the synchronization service to the terminal. For example, the AF may request a 5GS synchronization service from the TSCTSF/NEF. At this time, the AF may designate a condition of the terminal. For example, the AF may provide information for the UE registration with respect to an identifier (e.g., a UE ID, a UE group ID, etc.) such as GPSI of the terminal. Also, the AF may provide information for PDU session setup such as DNN/S-NSSAI. In addition, the AF may provide a coverage condition. Herein, the coverage condition may indicate geographical location information (or location information). Herein, center coordinates may indicate a latitude and a longitude of the AF, and a radius may indicate a coverage range required by the AF. Alternatively, the center coordinates may indicate a location of the gNB, and the radius may indicate coverage serviceable by the gNB. The coverage condition may be preset in a service provider network. In this case, operation 910 may be omitted.

The NEF may change the geographic location information to coordinates and the radius. Alternatively, the location information may be expressed based on a cell ID. The UE ID received as the GPSI may be changed to an ID such as SUPI used only inside the 5GS. Changing the TSCTSF or a separate 5GS sync NF may be performed inside the 5GC.

If operation 910 precedes operation 900, the AF may provide information of the UE registration with respect to the identifier (e.g., a UE ID, a UE group ID, etc.) such as GPSI of the terminal. Also, the AF may provide information of the PDU session setup such as DNN/S-NSSAI. The information such as DNN/S-NS SAI may be stored in the UDR. If identifying terminal registration satisfying a specific condition in operation 900, the UDR may notify this to the TSCTSF to perform from operation 920.

In operation 920, the TSCTSF or the 5GS sync NF may transmit to the AMF a request to notify of a terminal identified to match based on the location information. For example, the TSCTSF or the NEF may transmit the subscription information including the location information and the range to the AMF. Hence, the AMF, upon receiving the subscription information, may identify the request to notify the terminal identified to match based on the subscription information.

In operation 930, the AMF may notify terminals matched based on the location information to the TSCTSF or the 5GS sync NF.

In so doing, the TSCTSF or the 5GS sync NF may obtain a 5GS sync status. The 5GS may have a plurality of sync sources, and the current sync status may differ depending on the sync source. For example, if the 5GS uses a first timing source and the reference UTC indicates 1 hour 00 minute 00 second, the 5GS absolute time may indicate 1 hour 00 minute 01 second. That is, a different (error) of 1 second may occur every one hour between the 5GS absolute time and the UTC. In this case, information of the 1-second error based on 1 hour may be the sync status. By contrast, if the 5GS uses a second timing source and the reference UTC indicates 1 hour 00 minute 00 second, the 5GS absolute time may indicate 1 hour 00 minute 0.5 second. That is, a different (error) of 1 second may occur every one hour between the 5GS absolute time and the UTC. In this case, information of the 1-second error based on 1 hour may be the sync status.

In operation 940, the TSCTSF or the 5GS sync NF may forward the 5GS sync status and/or the coverage condition to the AF. That is, the TSCTSF or the 5GS sync NF may report the 5GS sync status and/or the coverage condition to the AF.

In operation 942, the AF may identify the coverage condition. The AF may identify the 5GS sync status. By identifying the two conditions, the AF may identify whether the terminal requirement is satisfied. If satisfying the terminal requirement, the 5GS may perform internal setup to provide the sync accuracy to the corresponding terminal, and the AF may determine to request the 5GS to provide the synchronization service to the terminal.

In operation 950, the AF may request the 5GS to internally set up to provide the sync accuracy to the corresponding terminal and request the TSCTSF or the 5GS sync NF to provide the synchronization service to the terminal.

In operation 952, the UE may set up the PDU session, and the SMF may identify UDM subscription information with respect to the sync serviceability. Operation 952 may precede operation 910. In this case, operation 954 may be performed after operation 950. Operation 952 may be omitted.

In operation 954, the TSCTSF or the 5GS sync NF may request the AFM to notify of a terminal matched based on the location information. Operation 954 may be omitted.

In operation 956, the AMF may notify the TSCTSF or the 5GS sync NF of terminals matched based on the location information. Operation 956 may be omitted.

In operation 958, the TSCTSF or the 5GS sync NF may identify whether the terminal requirement is satisfied, by considering time sync accuracy required by the terminal and the current time sync status provided by the 5GS. If satisfying the terminal requirement, the 5GS may perform internal setup to provide the sync accuracy to the corresponding terminal. The 5GS may determine whether to forward the 5GS sync status to the UE. In addition, the 5GS sync status is changed, operation 958 may be performed.

The 5GS may select a method for delivering the sync status to the UE or the AF. That is, if only one PDU session is established at one terminal, the method of FIG. 8 may be applied. In this case, if the corresponding terminal identifies a plurality of PDU sessions established, the corresponding terminal may change to apply the method of FIG. 8. Alternatively, if it is necessary to deliver the 5GS sync status to a plurality of terminals of one cell, a method of FIG. 10 may be adopted. In this case, if a corresponding cell includes only one terminal, the method of FIG. 9 may be applied.

If a sync accuracy level or a time error budget provided by the 5GS in operation 962, operation 972 and operation 982 is changed, the TSCTSF/NEF may forward specific terminal information and sync error budget information of the corresponding terminal to the RAN node (or the gNB) via the PCF and the AMF. The RAN node may increase or decrease a SIB period based on the sync error budget information provided from the 5GC, or increase or decrease a latency measurement period between the base station and the terminal to measure a timing advance value of each terminal. Hence, the RAN node may control to satisfy the sync accuracy requirement of the UE.

In operation 962, the TSCTSF or the 5GS sync NF may transmit to the UDM/UDR a request (e.g., Npcf_Authorization) to notify if sync accuracy setup request information is changed. If the sync accuracy setup request information is changed, the UDR may request the sync accuracy setup from the PCF. Also, the UDR may notify the TSCTSF of the sync accuracy setup request information change.

In operation 972, the PCF may transmit to the AMF a policy information change message (e.g., Npcf_AM_PolicyControl_UpdateNotify) including the sync accuracy requirement such as sync error budget.

In operation 982, the AMF may transmit a policy update request (e.g., Notify UE about PCF update) to the gNB. The gNB may increase or decrease the SIB period based on the received sync accuracy requirement such as sync error budget, or increase or decrease the latency measurement period between the base station and the terminal to measure the timing advance value of each terminal.

In operation 960, operation 970, and operation 980, the TSCTSF or the 5GS sync NF may forward the 5GS sync status to the corresponding UE.

In operation 960, the TSCTSF or the 5GS sync NF may transmit to the UDM/UDR a request (e.g., Npcf_Authorization) to notify if the sync accuracy setup request information is changed. If the sync accuracy setup request information is changed, the UDR may request the sync accuracy setup from the PCF. Also, the UDR may notify the TSCTSF of the sync accuracy setup request information change.

In operation 970, the PCF may forward 5GS sync status information to the AMF, to deliver the 5GS sync status to the terminal.

In operation 980, if the AMF forwards the 5GS sync status information to the terminal, the terminal may identify whether the 5GS satisfies the sync accuracy requested by the terminal, and perform adjustment based on the current sync status. For example, the terminal may modify an application operation, by reflecting the difference from the UTC.

After operation 970, if the terminal enters the idle mode, the corresponding terminal may be paged in operation 974 and then operation 980 may be performed.

The AF may forward the 5GS status to the UE using the user plane in operation 990. The UE may confirm the 5GS status at the AF using the user plane in operation 992. Operation 990 or operation 992 may be omitted.

Through the signaling shown in FIG. 9, the 5GS may notify the sync status to the AF. Hence, the AF may request the 5GS (e.g., the TSCTSF or the 5GS sync NF) to forward the sync status or the 5GS sync status to the terminal. The 5GS receiving the request from the AF may forward the sync status information to the terminal using AM NAS signaling.

FIG. 10 illustrates an example in which a 5GC notifies a sync status to an AF, and the 5GC transmits AS (SIB, RRC signaling) signaling to a terminal at a request of the AF according to embodiments of the disclosure.

Description on network entities and NFs of FIG. 10 may apply the same descriptions as FIG. 1A through FIG. 3B. Accordingly, specific description thereof shall be omitted. FIG. 10 illustrates that the UE includes the DS-TT, but the disclosure is not limited thereto. That is, the UE may be connected to the DS-TT as shown in FIG. 3A. The TSCTSF and the NEF may be independently configured as separate NFs, or may be configured as one NF. A 5GS sync NF to be described may indicate an NF for performing specific function and operation. In addition, the embodiment of FIG. 10 may include redundant operations of FIG. 4, and description thereof shall be omitted.

The signaling example of FIG. 10 is advantageous if the same 5GS sync status is to be delivered to a plurality of terminals of a specific cell. However, the embodiment of FIG. 10 is not applied only to the above situation, and the above example is merely to facilitate the explanation.

In operation 1000, the terminal may transmit a requirement related to time sync accuracy to the 5GC through 5GS registration. The 5GC may identify subscription information of whether the terminal may receive the sync service. If identifying the subscription information, the 5GC may further store details of the subscription information in the UDM.

In operation 1010, the AF may request the 5GC to provide the synchronization service to the terminal. For example, the AF may request a 5GS synchronization service from the TSCTSF/NEF. At this time, the AF may designate a condition of the terminal. For example, the AF may provide information for the UE registration with respect to an identifier (e.g., a UE ID, a UE group ID, etc.) such as GPSI of the terminal. Also, the AF may provide information for PDU session setup such as DNN/S-NSSAI. In addition, the AF may provide a coverage condition. Herein, the coverage condition may indicate geographical location information (or location information). Herein, the center coordinates may indicate a latitude and a longitude of the AF, and the radius may indicate a coverage range required by the AF. Alternatively, the center coordinates may indicate a location of the gNB, and the radius may indicate coverage serviceable by the gNB. The coverage condition may be preset in a service provider network. In this case, operation 1010 may be omitted.

The NEF may change the geographic location information to the coordinates and the radius. Alternatively, the location information may be expressed based on a cell ID. The UE ID received as the GPSI may be changed to an ID such as SUPI used only inside the 5GS. Changing the TSCTSF or a separate 5GS sync NF may be performed inside the 5GC.

If operation 1010 precedes operation 1000, the AF may provide information of the UE registration with respect to the identifier (e.g., a UE ID, a UE group ID, etc.) such as terminal GPSI. Also, the AF may provide information of the PDU session setup such as DNN/S-NSSAI. The information such as DNN/S-NSSAI may be stored in the UDR. If identifying terminal registration satisfying a specific condition in operation 1000, the UDR may notify this to the TSCTSF to perform from operation 1020.

In operation 1020, the TSCTSF or the 5GS sync NF may transmit to the AMF a request to notify of a terminal id entified to match based on the location information. For example, the TSCTSF or the NEF may transmit subscription information including the location information and the range to the AMF. Hence, the AMF, upon receiving the subscription information, may identify the request to notify of the terminal identified to match based on the subscription information.

In operation 1030, the AMF may notify terminals matched based on the location information to the TSCTSF or the 5GS sync NF.

In this case, the TSCTSF or the 5GS sync NF may obtain a 5GS sync status. The 5GS may have a plurality of sync sources, and the current sync status may differ depending on the sync source. For example, if the 5GS uses a first timing source and the reference UTC indicates 1 hour 00 minute 00 second, the 5GS absolute time may indicate 1 hour 00 minute 01 second. That is, a different (error) of 1 second may occur every one hour between the 5GS absolute time and the UTC. In this case, information of the 1-second error based on 1 hour may be the sync status. By contrast, if the 5GS uses a second timing source and the reference UTC indicates 1 hour 00 minute 00 second, the 5GS absolute time may indicate 1 hour 00 minute 0.5 second. That is, a different (error) of 1 second may occur every one hour between the 5GS absolute time and the UTC. In this case, information of the 1-second error based on 1 hour may be the sync status.

In operation 1040, the TSCTSF or the 5GS sync NF may forward the 5GS sync status and/or the coverage condition to the AF. That is, the TSCTSF or the 5GS sync NF may report the 5GS sync status and/or the coverage condition to the AF.

In operation 1042, the AF may identify the coverage condition. The AF may identify the 5GS sync status. By identifying the two conditions, the AF may identify whether the terminal requirement is satisfied. If satisfying the terminal requirement, the 5GS may perform internal setup to provide the sync accuracy to the corresponding terminal, and the AF may determine to request the 5GS to provide the synchronization service to the terminal.

In operation 1050, the AF may request the 5GS to internally set up to provide the sync accuracy to the corresponding terminal and request the TSCTSF or the 5GS sync NF to provide the synchronization service to the terminal.

In operation 1052, the UE may set up the PDU session, and the SMF may identify UDM subscription information with respect to the sync serviceability. Operation 1052 may precede operation 1010. In this case, operation 1054 may be performed after operation 1050. Operation 1052 may be omitted.

In operation 1054, the TSCTSF or the 5GS sync NF may transmit to the AFM a request to notify of a terminal matched based on the location information. Operation 1054 may be omitted.

In operation 1056, the AMF may notify the TSCTSF or the 5GS sync NF of terminals matched based on the location information. Operation 1056 may be omitted.

In operation 1058, the TSCTSF or the 5GS sync NF may determine whether the terminal requirement is satisfied, by considering time sync accuracy required by the terminal and the current time sync status provided by the 5GS. If satisfying the terminal requirement, the 5GS may perform internal setup to provide the sync accuracy to the corresponding terminal. The 5GS may determine whether to deliver the 5GS sync status to the UE. In addition, if the 5GS sync status is changed, operation 1058 may be performed.

The 5GS may select a method for delivering the sync status to the UE or the AF. That is, if the 5GS sync status is delivered to one terminal of one cell, the method of FIG. 8 or FIG. 9 may be applied. In this case, if it is necessary to deliver the 5GS sync status to a plurality of terminals, the method of FIG. 10 may be adopted.

If a sync accuracy level or a time error budget provided by the 5GS in operation 1062, operation 1072 and operation 1082 is changed, the TSCTSF/NEF may forward specific terminal information and sync error budget information of the corresponding terminal to the RAN node (or the gNB) via the PCF and the AMF. The RAN node may increase or decrease a SIB period based on the sync error budget information provided from the 5GC, or increase or decrease a latency measurement period between the base station and the terminal to measure a timing advance value of each terminal. Hence, the RAN node may control to satisfy the sync accuracy requirement of the terminal.

In operation 1062, the TSCTSF or the 5GS sync NF may transmit to the UDM/UDR a request (e.g., Npcf_Authorization) to notify if sync accuracy setup request information is changed. If the sync accuracy setup request information is changed, the UDR may request the sync accuracy setup from the PCF. The UDR may notify the TSCTSF of the sync accuracy setup request information change.

In operation 1072, the PCF may transmit to the AMF a policy information change message (e.g., Npcf_AM_PolicyControl_UpdateNotify) including the sync accuracy requirement such as sync error budget.

In operation 1082, the AMF may transmit a policy update request (e.g., Notify UE about PCF update) to the gNB. The gNB may increase or decrease the SIB period based on the received sync accuracy requirement such as sync error budget, or increase or decrease the latency measurement period between the base station and the terminal to measure the timing advance value of each terminal.

In operation 1060, operation 1070, operation 1080, and operation 1090, the TSCTSF or the 5GS sync NF may deliver the 5GS sync status to the corresponding UE.

In operation 1060, the TSCTSF or the 5GS sync NF may transmit to the UDM/UDR a request (e.g., Npcf_Authorization) to notify a change of the sync accuracy setup request information. If the sync accuracy setup request information is changed, the UDR may request the sync accuracy setup from the PCF. The UDR may notify the TSCTSF of the sync accuracy setup request information change.

In operation 1070, the PCF may forward the 5GS sync status information to the AMF, to deliver the 5GS sync status to the terminal.

In operation 1080, the AMF may froward the policy update request to the gNB. The gNB may increase or decrease the SIB period based on the received sync accuracy requirement such as sync error budget. Also, the gNB may increase or decrease the latency measurement period between the base station and the terminal to measure the timing advance value of each terminal.

In operation 1090, the gNB may forward the sync status to the terminal using the AS (e.g., SIB, RRC signaling) signaling. If the terminal receives the 5GS sync status, the terminal may identify whether the 5GS satisfies the sync accuracy requested by the terminal, and perform adjustment based on the current sync status. For example, the terminal may modify an application operation, by reflecting the difference from the UTC.

The AF may forward the 5GS status to the UE using the user plane in operation 1092. The UE may confirm the 5GS status at the AF using the user plane in operation 1094. Operation 1092 or operation 1094 may be omitted.

Through the signaling shown in FIG. 10, the 5GS may notify the sync status to the AF. Hence, the AF may request the 5GS (e.g., the TSCTSF or the 5GS sync NF) to forward the sync status or the 5GS sync status to the terminal. The 5GS receiving the request from the AF may deliver sync status information to the terminal using the AS NAS signaling.

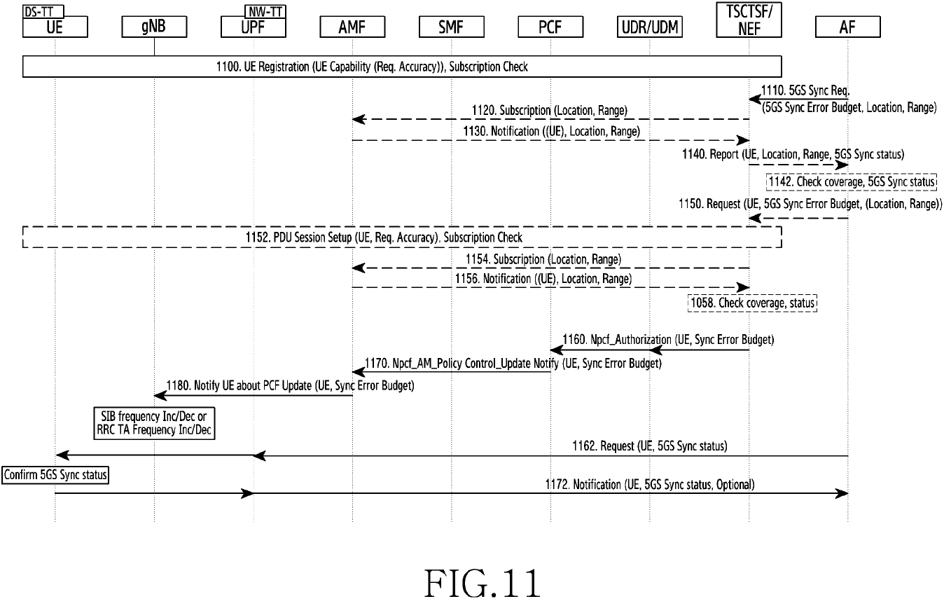

FIG. 11 illustrates an example in which a 5GC notifies a sync status to an AF, and the AF forwards the sync status to a terminal via a UP according to embodiments of the disclosure.

Description on network entities and NFs of FIG. 11 may apply the same descriptions as FIG. 1A through FIG. 3B. Accordingly, specific description thereof shall be omitted. FIG. 11 illustrates that the UE includes the DS-TT, but the disclosure is not limited thereto. That is, the UE may be connected to the DS-TT as shown in FIG. 3A. The TSCTSF and the NEF may be independently configured as separate NFs, or may be configured as one NF. A 5GS sync NF to be described may indicate an NF for performing specific function and operation. In addition, the embodiment of FIG. 11 may include redundant operations of FIG. 4, and description thereof shall be omitted.

The signaling example of FIG. 11 may be used if it is necessary to minimize CP change. However, the embodiment of FIG. 11 is not applied only to the above situation, and the above example is merely to facilitate the explanation.

In operation 1100, the terminal may transmit a requirement related to time sync accuracy to the 5GC through 5GS registration. The 5GC may identify subscription information of whether the terminal may receive the sync service. If identifying the subscription information, the 5GC may further store details of the subscription information in the UDM.

In operation 1110, the AF may request the 5GC to provide the synchronization service to the terminal. For example, the AF may request a 5GS synchronization service from the TSCTSF/NEF. At this time, the AF may designate a condition of the terminal. For example, the AF may provide information for the UE registration with respect to an identifier (e.g., a UE ID, a UE group ID, etc.) such as GPSI of the terminal. Also, the AF may provide information for PDU session setup such as DNN/S-NSSAI. In addition, the AF may provide a coverage condition. Herein, the coverage condition may indicate geographical location information (or location information). Herein, the center coordinates may indicate a latitude and a longitude of the AF, and the radius may indicate a coverage range required by the AF. Alternatively, the center coordinates may indicate a location of the gNB, and the radius may indicate coverage serviceable by the gNB. The coverage condition may be preset in a service provider network. In this case, operation 1110 may be omitted.

The NEF may change the geographic location information to the coordinates and the radius. Alternatively, the location information may be expressed based on a cell ID. The UE ID received as the GPSI may be changed to an ID such as SUPI used only inside the 5GS. Changing the TSCTSF or a separate 5GS sync NF may be performed inside the 5GC.

If operation 1110 precedes operation 1100, the AF may provide information of the UE registration with respect to the identifier (e.g., a UE ID, a UE group ID, etc.) such as terminal GPSI. Also, the AF may provide information of the PDU session setup such as DNN/S-NSSAI. The information such as DNN/S-NS SAI may be stored in the UDR. If identifying terminal registration satisfying a specific condition in operation 1100, the UDR may notify this to the TSCTSF to perform from operation 1120.

In operation 1120, the TSCTSF or the 5GS sync NF may transmit to the AMF a request to notify a terminal E identified to match based on the location information. For example, the TSCTSF or the NEF may transmit subscription information including the location information and the range to the AMF. Hence, the AMF, upon receiving the subscription information, may identify the request to notify the terminal E identified to match based on the subscription information.

In operation 1130, the AMF may notify terminals matched based on the location information to the TSCTSF or the 5GS sync NF.

In so doing, the TSCTSF or the 5GS sync NF may obtain a 5GS sync status. The 5GS may have a plurality of sync sources, and the current sync status may differ depending on the sync source. For example, if the 5GS uses a first timing source and the reference UTC indicates 1 hour 00 minute 00 second, the absolute time of the 5GS may indicate 1 hour 00 minute 01 second. That is, a different (error) of 1 second may occur every one hour between the 5GS absolute time and the UTC. In this case, information of the 1-second error based on 1 hour may be the sync status. By contrast, if the 5GS uses a second timing source and the reference UTC indicates 1 hour 00 minute 00 second, the 5GS absolute time may indicate 1 hour 00 minute 0.5 second. That is, a different (error) of 1 second may occur every one hour between the 5GS absolute time and the UTC. In this case, information of the 1-second error based on 1 hour may be the sync status.

In operation 1140, the TSCTSF or the 5GS sync NF may forward the 5GS sync status and/or the coverage condition to the AF. In other words, the TSCTSF or the 5GS sync NF may report the 5GS sync status and/or the coverage condition to the AF.

In operation 1142, the AF may identify the coverage condition. The AF may identify the 5GS sync status. By identifying the two conditions, the AF may identify whether the terminal requirement is satisfied. If satisfying the terminal requirement, the 5GS may perform internal setup to provide the sync accuracy to the corresponding terminal, and the AF may determine to request the 5GS to provide the synchronization service to the terminal.

In operation 1150, the AF may request the 5GS to internally set up to provide the sync accuracy to the corresponding terminal and request the TSCTSF or the 5GS sync NF to provide the synchronization service to the terminal.

In operation 1152, the UE may set up a PDU session, and the SMF may identify UDM subscription information with respect to the sync serviceability. Operation 1152 may precede operation 1110. In this case, operation 1154 may be performed after operation 1150. Operation 1152 may be omitted.

In operation 1154, the TSCTSF or the 5GS sync NF may transmit to the AFM a request to notify of a terminal identified to match based on the location information. Operation 1154 may be omitted.

In operation 1156, the AMF may notify the TSCTSF or the 5GS sync NF of terminals matched based on the location information. Operation 1156 may be omitted.

In operation 1158, the TSCTSF or the 5GS sync NF may determine whetherthe terminal requirement is satisfied, by considering time sync accuracy required by the terminal and the current time sync status provided by the 5GS. If satisfying the terminal requirement, the 5GS may perform internal setup to provide the sync accuracy to the corresponding terminal. The 5GS may determine whether to deliver the 5GS sync status to the UE. In addition, if the 5GS sync status is changed, operation 1158 may be performed.

If a sync accuracy level or a time error budget provided by the 5GS in operation 1160, operation 1170 and operation 1180 is changed, the TSCTSF/NEF may forward specific terminal information and sync error budget information of the corresponding terminal to the RAN node (or the gNB) via the PCF and the AMF. The RAN node may increase or decrease a SIB period based on the sync error budget information provided from the 5GC, or increase or decrease a latency measurement period between the base station and the terminal to measure a timing advance value of each terminal. Hence, the RAN node may control to satisfy the sync accuracy requirement of the terminal.

In operation 1160, the TSCTSF or the 5GS sync NF may transmit to the UDM/UDR a request (e.g., Npcf_Authorization) to notify if sync accuracy setup request information is changed. If the sync accuracy setup request information is changed, the UDR may request the sync accuracy setup from the PCF. Also, the UDR may notify the TSCTSF of the sync accuracy setup request information change.

In operation 1170, the PCF may transmit to the AMF a policy information change message (e.g., Npcf_AM_PolicyControl_UpdateNotify) including the sync accuracy requirement such as sync error budget.

In operation 1180, the AMF may transmit a policy update request (e.g., Notify UE about PCF update) to the gNB. The gNB may increase or decrease the SIB period based on the received sync accuracy requirement such as sync error budget, or increase or decrease the latency measurement period between the base station and the terminal to measure the timing advance value of each terminal.

In operation 1162, the AF may forward the 5GS sync status to the UE using the user plane. If receiving the 5GS sync status, the terminal may identify whether the 5GS satisfies the sync accuracy requested by the terminal, and perform adjustment based on the current sync status. For example, the terminal may modify an application operation, by reflecting the difference from the UTC.

In operation 1172, the UE may confirm the 5GS sync status at the AF using the user plane. Operation 1172 may be omitted.

Through the signaling shown in FIG. 11, the 5GS may notify the sync status or the 5GS sync status to the AF. Hence, the AF may forward the 5GS sync status to the terminal using the UP.

As set forth above, according to an embodiment of the disclosure, a method performed by a 5th generation (5G) core network (5GC) entity for timing synchronization in a wireless communication system, the method comprising: transmitting, to an access and mobility management function (AMF), subscription information including location information of at least one of an application function (AF) or a base station, receiving, from the AMF, information on a user equipment (UE) identified based on the location information; identifying a sync status for providing a synchronization service, based on the location information and the information on the UE; and transmitting, to a policy and charging function (PCF), information on the sync status.

In an embodiment, further comprising: receiving, from the AF, information for requesting the synchronization service including the location information, wherein the information for requesting the synchronization service includes at least one of a sync error budget, an identifier of the UE, protocol data unit (PDU) session setup information, or the location information.

In an embodiment, wherein the information on the sync status is transmitted using session management (SM) non-access stratum (NAS) signaling in case that the synchronization service is used in one of PDU sessions established at the UE.

In an embodiment, wherein the information on the sync status is transmitted using AM NAS signaling in case that the synchronization service is used in PDU sessions established at the UE.

In an embodiment, wherein the information on the sync status is transmitted using AS signaling, and the AS signaling is one of system information block (SIB) or radio resource control (RRC) signaling in case that the information on the sync status is simultaneously transmitted to a plurality of UEs of a cell covering the UE.

In an embodiment, wherein the information on the sync status is transmitted from the AF to the UE via a user plane (UP).

In an embodiment, further comprising: transmitting, to at least one of a user data management (UDM) or a unified data repository (UDR), a request message for notifying whether a synchronization accuracy setup request information is changed in case that the synchronization accuracy setup request information is changed.

In an embodiment, wherein the information on the sync status includes time difference information of an absolute time of the wireless communication system and a coordinated universal time (UTC), according to a timing source used in the wireless communication system.

In an embodiment, further comprising: Transmitting, to the AF, at least one of the information on the sync status or the location information.

In an embodiment, wherein the 5GC entity comprises at least one of a network exposure function (NEF) or a time sensitive communications and time synchronization function (TSCTSF).

As set forth above, according to an embodiment of the disclosure, a 5th generation (5G) core network (5GC) entity in a wireless communication system, comprising: at least one transceiver; and at least one processor functionally coupled with the at least one transceiver, wherein the at least one processor is configured to: transmit, to an access and mobility management function (AMF), subscription information including location information of at least one of an application function (AF) or a base station; receive, from the AMF, information on a user equipment (UE) identified based on the location information; identify a sync status for providing a synchronization service, based on the location information and the information on the UE; and transmit, to a policy and charging function (PCF), information on the sync status.

In an embodiment, further comprising: receive, from the AF, information for requesting the synchronization service including the location information, wherein the information for requesting the synchronization service includes at least one of a sync error budget, an identifier of the UE, protocol data unit (PDU) session setup information, or the location information.

In an embodiment, wherein the information on the sync status is transmitted using session management (SM) non-access stratum (NAS) signaling in case that the synchronization service is used in one of PDU sessions established at the UE.

In an embodiment, wherein the information on the sync status is transmitted using AM NAS signaling in case that the synchronization service is used in PDU sessions established at the UE.

In an embodiment, wherein the information on the sync status is transmitted using AS signaling, and the AS signaling is one of system information block (SIB) or radio resource control (RRC) signaling in case that the information on the sync status is simultaneously transmitted to a plurality of UEs of a cell covering the UE.

In an embodiment, wherein the information on the sync status is transmitted from the AF to the UE via a user plane (UP).

In an embodiment, transmitting, to at least one of a user data management (UDM) or a unified data repository (UDR), a request message for notifying whether a synchronization accuracy setup request information is changed in case that the synchronization accuracy setup request information is changed.

In an embodiment, wherein the information on the sync status includes time difference information of an absolute time of the wireless communication system and a coordinated universal time (UTC), according to a timing source used in the wireless communication system.

In an embodiment, transmitting, to the AF, at least one of the information on the sync status or the location information.

In an embodiment, wherein the 5GC entity comprises at least one of a network exposure function (NEF) or a time sensitive communications and time synchronization function (TSCTSF).

The methods according to the embodiments described in the claims or the specification of the disclosure may be implemented in software, hardware, or a combination of hardware and software.

As for the software, a computer-readable storage medium storing one or more programs (software modules) may be provided. One or more programs stored in the computer-readable storage medium may be configured for execution by one or more processors of an electronic device. One or more programs may include instructions for controlling an electronic device to execute the methods according to the embodiments described in the claims or the specification of the disclosure.

Such a program (software module, software) may be stored to a random access memory, a non-volatile memory including a flash memory, a read only memory (ROM), an electrically erasable programmable ROM (EEPROM), a magnetic disc storage device, a compact disc (CD)-ROM, a digital versatile disc (DVD) or other optical storage device, and a magnetic cassette. Alternatively, it may be stored to a memory combining part or all of those recording media. A plurality of memories may be included.

Also, the program may be stored in an attachable storage device accessible via a communication network such as internet, intranet, local area network (LAN), wide LAN (WLAN), or storage area network (SAN), or a communication network by combining these networks. Such a storage device may access a device which executes an embodiment of the disclosure through an external port. In addition, a separate storage device on the communication network may access the device which executes an embodiment of the disclosure.

In the specific embodiments of the disclosure, the components included in the disclosure are expressed in a singular or plural form. However, the singular or plural expression is appropriately selected according to a provided situation for the convenience of explanation, the disclosure is not limited to a single component or a plurality of components, the components expressed in the plural form may be configured as a single component, and the components expressed in the singular form may be configured as a plurality of components.

Meanwhile, in the drawings for explaining the method of the disclosure, the order of description does not necessarily correspond to the execution order, and the precedence relationship may be changed or may be executed in parallel.

Alternatively, in the drawings explaining the method of the disclosure, some component may be omitted and only some element may be included therein without departing from the essential spirit and the scope of the disclosure.

Further, the method of the disclosure may be fulfilled by combining some or all of the contents of each embodiment without departing from the essential spirit and the scope of the disclosure.

Meanwhile, while the specific embodiment has been described in the detailed explanations of the disclosure, it will be noted that various changes may be made therein without departing from the scope of the disclosure. Therefore, the scope of the disclosure should not be limited to the described embodiments and should be defined by the claims described below as well as the claims and their equivalents.

Although the disclosure has been described with various embodiments, various changes and modifications may be suggested to one skilled in the art. It is intended that the disclosure encompass such changes and modifications as fall within the scope of the appended claims.

What is claimed is:

1. A method performed by a network entity for performing a timing synchronization in a wireless communication system, the method comprising:
transmitting, to an access and mobility management function (AMF), subscription information including location information associated with at least one of an application function (AF) or a base station;
receiving, from the AMF, a user equipment (UE) information based on the location information;
identifying, based on the location information and the UE information, sync status information for providing a synchronization service; and
transmitting, to a policy and charging function (PCF), the sync status information.

2. The method of claim 1, further comprising:
receiving, from the AF, synchronization service request information including the location information for requesting the synchronization service,
wherein the synchronization service request information includes at least one of a sync error budget, an identifier of the UE, protocol data unit (PDU) session setup information, or the location information.

3. The method of claim 1, wherein the sync status information is transmitted using a session management (SM) non-access stratum (NAS) signaling in case that the synchronization service is performed in one of PDU sessions established at the UE.

4. The method of claim 1, wherein the sync status information is transmitted using an AM NAS signaling in case that the synchronization service is performed in PDU sessions established at the UE.

5. The method of claim 1, wherein the sync status information is transmitted using an AS signaling, and wherein the AS signaling is one of a system information block (SIB) or a radio resource control (RRC) signaling in case that the sync status information is simultaneously transmitted to a plurality of UEs in a cell where the UE belongs to.

6. The method of claim 1, wherein the sync status information is transmitted from the AF to the UE via a user plane (UP).

7. The method of claim 1, further comprising:
transmitting, to at least one of a user data management (UDM) or a unified data repository (UDR), a request message for notifying whether a synchronization accuracy setup request information is changed in case that the synchronization accuracy setup request information is changed.

8. The method of claim 1, wherein the sync status information includes, based on a timing source used in the wireless communication system, time difference information associated with an absolute time of the wireless communication system and a coordinated universal time (UTC).

9. The method of claim 1, further comprising:
transmitting, to the AF, at least one of the sync status information or the location information.

10. The method of claim 1, wherein the network entity is a fifth generation (5G) core network (5GC) entity comprising at least one of a network exposure function (NEF) or a time sensitive communications and time synchronization function (TSCTSF).

11. A network entity for performing a timing synchronization in a wireless communication system, the network entity comprising:
at least one transceiver; and
at least one processor operably coupled with the at least one transceiver, wherein the at least one processor is configured to:
transmit, to an access and mobility management function (AMF), subscription information including location information associated with at least one of an application function (AF) or a base station,
receive, from the AMF, a user equipment (UE) information based on the location information,
identify, based on the location information and the information on the UE, sync status information for providing a synchronization service, and
transmit, to a policy and charging function (PCF), the sync status information.

12. The network entity of claim 11, wherein the at least one processor is further configured to:
receive, from the AF, synchronization service request information including the location information for requesting the synchronization service, and
wherein the synchronization service request information includes at least one of a sync error budget, an identifier of the UE, protocol data unit (PDU) session setup information, or the location information.

13. The network entity of claim 11, wherein the sync status information is transmitted using a session management (SM) non-access stratum (NAS) signaling in case that the synchronization service is performed in one of PDU sessions established at the UE.

14. The network entity of claim 11, wherein the sync status information is transmitted using an AM NAS signaling in case that the synchronization service is performed in PDU sessions established at the UE.

15. The network entity of claim 11, wherein the sync status information is transmitted using an AS signaling, and wherein AS signaling is one of a system information block (SIB) or a radio resource control (RRC) signaling in case that the sync status information is simultaneously transmitted to a plurality of UEs in a cell wherein the UE belongs to.

16. The network entity of claim 11, wherein the sync status information is transmitted from the AF to the UE via a user plane (UP).

17. The network entity of claim 11, wherein the at least one processor is further configured to:
transmit, to at least one of a user data management (UDM) or a unified data repository (UDR), a request message for notifying whether a synchronization accuracy setup request information is changed in case that the synchronization accuracy setup request information is changed.

18. The network entity of claim 11, wherein the sync status information includes, based on a timing source used in the wireless communication system, time difference information associated with an absolute time of the wireless communication system and a coordinated universal time (UTC).

19. The network entity of claim 11, wherein the at least one processor is further configured to:
transmit, to the AF, at least one of the sync status information or the location information.

20. The network entity of claim 11, wherein the network entity is a fifth generation (5G) core network (5GC) entity comprising at least one of a network exposure function (NEF) or a time sensitive communications and time synchronization function (TSCTSF).
